(19) United States
(12) Patent Application Publication
(10) Pub. No.: US 2022/0147961 A1
(43) Pub. Date: May 12, 2022

(54) METHOD FOR DISTRIBUTING COLLECTABLES OWNERSHIP BY USING MULTI-SIGNATURE BASED ON BLOCKCHAIN NETWORKS AND ONLINE TRANSACTION SERVER USING THE SAME

(71) Applicant: Seoul Auction blue, Seoul (KR)

(72) Inventors: Yeo Jin Yoon, Yongin-si (KR); Jung Bong Lee, Seoul (KR); Sang Hoon Hyun, Seoul (KR); Jae Do Kim, Seoul (KR); Hyo Won Cho, Seoul (KR)

(21) Appl. No.: 17/515,749

(22) Filed: Nov. 1, 2021

(30) Foreign Application Priority Data
Nov. 9, 2020 (KR) 1020200148347

(51) Int. Cl. G06Q 20/12; G06Q 20/40; G06Q 20/38; G06Q 20/36; H04L 9/14; H04L 9/32; H04L 9/08

(52) U.S. Cl. CPC G06Q 20/1235; G06Q 2220/12; G06Q 20/38215; G06Q 20/3825; G06Q 20/3829; G06Q 20/36; G06Q 20/389; H04L 9/14; H04L 9/3213; H04L 9/3247; H04L 9/0825; H04L 9/3236; H04L 2209/38; H04L 2209/603; G06Q 20/401

(57) ABSTRACT

A method for distributing collectable ownership by using multi-signatures based on blockchain networks, including steps of: (a) an online transaction server, in response to acquiring a distribution request for a collectable from an owner, (i) generating an ownership token contract, (ii) generating a contract registering transaction, and (iii) broadcasting the contract registering transaction to a blockchain network, to thereby instruct the blockchain nodes to (iii-1) verify the contract registering transaction, (iii-2) register the ownership token contract, included in the contract registering transaction in the blockchain network, and (iii-3) transfer an ownership token contract ID corresponding to the ownership token contract registered in the blockchain network to the online transaction server.

### FIELD OF THE DISCLOSURE

The present disclosure relates to a method and an online transaction server for distributing at least one collectable; and more particularly, to the method and the online transaction server for distributing the collectable by using multi-signatures based on blockchain networks.

### BACKGROUND OF THE DISCLOSURE

Referring to prior arts, it can be seen that various pieces of ownership information on collectables such as an artwork, a pair of expensive sneakers, a watch, etc. are stored and managed in a centralized database.

However, the centralized database poses an issue of high cost since the centralized database requires a centralized server and a centralized system.

Further, the centralized database may be modified or tampered with at any time due to a bug, an administrator's mistake or intention, and sometimes the information on the collectables might even get lost or does not exist (not recorded); and such reversibility of the information on the collectables has a bad impact on service reliability.

Furthermore, the collectables per se were trading in the prior arts, and therefore, there exist major problems of time restriction and space restriction.

Moreover, if only a single entity manages a digital wallet of a holder of ownership tokens, then there is a difficulty in preventing fraudulent activities initiated by the single entity.

Consequently, there is a need for an improved method to solve the above problems.

### SUMMARY OF THE DISCLOSURE

It is an object of the present disclosure to solve all the aforementioned problems.

It is another object of the present disclosure to allow multiple participants to jointly own an ownership of a collectable, in a similar way to owning stocks, and to store and manage each of distributed ownerships in a form of tokens on a blockchain.

It is still another object of the present disclosure to allow each of the distributed ownerships to be transferred in the form of the tokens.

It is still yet another object of the present disclosure to distribute a sale profit according to a ratio of the tokens owned by the participants when the collectable per se is sold.

It is still yet another object of the present disclosure to allow a third party to manage a digital wallet of a token owner on behalf of the token owner.

It is still yet another object of the present disclosure to prevent an erroneous transaction by allowing an ownership token transaction to require multi-signatures from each of multi-signers.

It is still yet another object of the present disclosure to propose a method for managing the distributed ownerships and a profit distribution system in connection therewith based on the blockchain, to thereby provide a safe, reliable, and efficient online collectable transacting environment.

In order to accomplish objects above and characteristic effects to be described later of the present disclosure, distinctive structures of the present disclosure are described as follows.

In accordance with one aspect of the present disclosure there is provided a method for distributing collectable ownership based on blockchain networks, including steps of: (a) an online transaction server, in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; and (b) the online transaction server, in response to acquiring each piece of ownership distribution participation information for participating in an ownership distribution of the collectable from each of a first buyer to an n-th buyer, wherein n is an integer equal to or larger than 1, according to an ownership distribution participation request for the collectable registered to distribute the ownership of the collectable, (i) requesting each of a first administrator to an m-th administrator, wherein m is an integer equal to or larger than 1, to sign at least one of the ownership token contract ID and ownership transferal information corresponding to the ownership distribution participation information, and (ii) in response to acquiring each of a first administrator signature value to a k-th administrator signature value, which is a signature value acquired by signing at least one of the ownership token contract ID and the ownership transferal information or at least one first hash value of at least one of the ownership token contract ID and the ownership transferal information with each of private keys from each of the first administrator to a k-th administrator, wherein k is an integer equal to or larger than 1 and equal to or less than m, (ii-1) generating an ownership transferal transaction which includes the ownership token contract ID, the ownership transferal information acquired by referring to the ownership distribution participation information, a second server signature value, which is a signature value of the online transaction server, and the first administrator signature value to the k-th administrator signature value, and (ii-2) broadcasting the ownership transferal transaction to the blockchain network, to thereby instruct the blockchain nodes of the blockchain network to (ii-2-1) verify the second server signature value and the first administrator signature value to the k-th administrator signature value, and (ii-2-2) in response to verifying the second server signature value and the first administrator signature value to the k-th administrator signature value, execute the ownership token contract corresponding to the ownership token contract ID and thus transfer ownership tokens corresponding to the collectable to the first buyer to the n-th buyer who have participated in the ownership distribution according to the ownership transferal information.

As one example, at the step of (b), the online transaction server, in response to acquiring the ownership distribution participation information which includes first buyer distribution participation information and n-th buyer distribution participation information from the first buyer to the n-th buyer upon a completion of distributing the ownership of the collectable, (i) requests each of the first administrator to the m-th administrator to sign at least one of the ownership token contract ID and the ownership transferal information, wherein the ownership transferal information includes a first buyer's digital wallet address to an n-th buyer's digital wallet address and a first cardinal number of the ownership tokens to be transferred to an n-th cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the first cardinal number of the ownership tokens to be transferred to the n-th cardinal number of the ownership tokens to be transferred respectively to the first buyer's digital wallet address to the n-th buyer's digital wallet address.

As one example, at the step of (b), the online transaction server, in response to acquiring the ownership distribution participation information which includes specific buyer distribution participation information upon a partial completion of distributing the ownership of the collectable by a specific buyer among the first buyer to the n-th buyer, (i) requests each of the first administrator to the m-th administrator to sign at least one of the ownership token contract ID and the ownership transferal information, wherein the ownership transferal information includes a specific buyer's digital wallet address and a specific cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the specific cardinal number of the ownership tokens to be transferred to the specific digital wallet address.

As one example, the ownership token contract includes information on an ownership token structure and an ownership token function corresponding to the collectable, wherein the ownership token structure includes information on the collectable, information on an ownership token ID, and a cardinal number of issued ownership tokens, wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and wherein the ownership token function includes at least part of an ownership token transferal function, an ownership token termination function, an ownership token balance checking function, an ownership token transfer history tracking function, an ownership token restriction function, an ownership token lookup function, an ownership token holder lookup function, an administrator address registering function, and a multi-signature values verifying function.

As one example, the method further includes a step of: (c) the online transaction server (i) allowing transferring of the ownership tokens to the first buyer to the n-th buyer through the blockchain network, (ii) allowing a specific buyer among the first buyer to the n-th buyer who received an ownership token transferal request from a new buyer to (ii-1) generate an ownership token transferal transaction which includes the ownership token contract ID, a new buyer's digital wallet address, a new cardinal number of the ownership tokens to be transferred, and a specific buyer signature value which is acquired by signing (ii-1-1) at least one of the ownership token contract ID, the new buyer's digital wallet address, and the new cardinal number of the ownership tokens to be transferred with a specific buyer private key of the specific buyer, or (ii-1-2) at least one third hash value of at least one of the ownership token contract ID, the new buyer's digital wallet address, and the new cardinal number of ownership tokens to be transferred with the specific buyer private key of the specific buyer, (ii-2) request the online transaction server to multi-sign (ii-2-1) at least one of the ownership token contract ID, the new buyer's digital wallet address, and the new cardinal number of the ownership tokens to be transferred with each of the private keys from each of the first administrator to the k-th administrator, or (ii-2-2) the third hash value of at least one of the ownership token contract ID, the new buyer's digital wallet address, and the new cardinal number of ownership tokens to be transferred with each of the private keys from each of the first administrator to the k-th administrator, to thereby acquire multi-signature values which include a first administrator transferal signature value to a k-th administrator transferal signature value from the first administrator to the k-th administrator, and thus (ii-3) broadcast an ownership token transferal request, which includes the ownership token transferal transaction and the multi-signature values, to the blockchain network, and (iii) instructing the blockchain nodes which received the ownership token transferal request to (iii-1) (iii-1-1) (iii-1-1-1) decrypt the specific buyer signature value and the first administrator transferal signature value to the k-th administrator transferal signature value by using a specific buyer public key of the specific buyer and each of the public keys of the first administrator to the k-th administrator, (iii-1-1-2) acquire at least one of the ownership token contract ID, the new buyer's digital wallet address and the new cardinal number of the ownership tokens to be transferred as a result of said (iii-1-1-1), and (iii-1-1-3) check whether the acquired at least one of the ownership token contract ID, the new buyer's digital wallet address, and the new cardinal number of the ownership tokens to be transferred matches with the at least one of the ownership token contract ID, the new buyer's digital wallet address, and the new cardinal number of the ownership tokens to be transferred included in the ownership token transferal request, to thereby verify the specific buyer signature value and the first administrator transferal signature value to the k-th administrator transferal signature value, or (iii-1-2) (iii-1-2-1) decrypt the specific buyer signature value and the first administrator transferal signature value to the k-th administrator transferal signature value by using the specific buyer public key of the specific buyer and each of the public keys of the first administrator to the k-th administrator, (iii-1-2-2) acquire the third hash value as a result of said (iii-1-2-1), (iii-1-2-3) generate a fourth hash value by hashing at least one of the ownership token contract ID, the new buyer's digital wallet address, and the new cardinal number of the ownership tokens to be transferred, and (iii-1-2-4) check whether the third hash value matches with the fourth hash value, to thereby verify the specific buyer signature value and the first administrator transferal signature value to the k-th administrator transferal signature value, and (iii-2) in response to verifying the specific buyer signature value and the first administrator transferal signature value to the k-th administrator transferal signature value, execute the ownership token contract, to thereby transfer the new cardinal number of the ownership tokens to be transferred to the new buyer's digital wallet address.

As one example, the method further includes a step of: (d) the online transaction server, in response to acquiring sale completion information, (i) sending an ownership token collection request to the first buyer to the n-th buyer for liquidating the ownership tokens corresponding to the collectable, (ii) allowing the first buyer to the n-th buyer to (ii-1) generate each of a first ownership token return transaction to an n-th ownership token return transaction which includes the ownership token contract ID, a transaction server's digital wallet address corresponding to the online transaction server, a first cardinal number of the ownership tokens to be returned to an n-th cardinal number of the ownership tokens to be returned, and each of a first buyer signature value to an n-th buyer signature value which is acquired by signing at least one of the ownership token contract ID, the transaction server's digital wallet address, the first cardinal number of the ownership tokens to be returned to the n-th cardinal number of the ownership tokens to be returned with each of a first buyer private key to an n-th buyer private key corresponding to each of the first buyer to the n-th buyer, to thereby broadcast the first ownership token return transaction to the n-th ownership token return transaction to the blockchain network, or (ii-2) generate each of the first ownership token return transaction to the n-th ownership token return transaction which includes the ownership token contract ID, the transaction server's digital wallet address, the first cardinal number of the ownership tokens to be returned to the n-th cardinal number of the ownership tokens to be returned, and each of the first buyer signature value to the n-th buyer signature value which is acquired by signing a fifth hash value with each of the first buyer private key to the n-th buyer private key, wherein the fifth hash value is acquired by hashing at least one of the ownership token contract ID, the transaction server's digital wallet address, and the first cardinal number of the ownership tokens to be returned to the n-th cardinal number of the ownership tokens to be returned, to thereby broadcast the first ownership token return transaction to the n-th ownership token return transaction to the blockchain network, and (iii) instructing the blockchain nodes to (iii-1) (iii-1-1) (iii-1-1-1) decrypt the first buyer signature value to the n-th buyer signature value by using the first buyer public key to the n-th buyer public key corresponding to the first buyer to the n-th buyer, (iii-1-1-2) acquire at least one of the ownership token contract ID, the transaction server's digital wallet address, and the first cardinal number of the ownership tokens to be returned to the n-th cardinal number of the ownership tokens to be returned as a result of said (iii-1-1-2), and (iii-1-1-3) check whether the acquired at least one of the ownership token contract ID, the transaction server's digital wallet address, and the first cardinal number of the ownership tokens to be returned to the n-th cardinal number of the ownership tokens to be returned matches with at least one of the ownership token contract ID, the transaction server's digital wallet address, and the first cardinal number of the ownership tokens to be returned to the n-th cardinal number of the ownership tokens to be returned included in the first ownership token return transaction to the n-th ownership token return transaction, to thereby verify the first buyer signature value to the n-th buyer signature value, or (iii-1-2) (iii-1-2-1) decrypt the first buyer signature value to the n-th buyer signature value by using the first buyer public key to the n-th buyer public key, (iii-1-2-2) acquire the fifth hash value as a result of said (iii-1-2-1), (iii-1-2-3) generate a sixth hash value by hashing at least one of the ownership token contract ID, the transaction server's digital wallet address, and the first cardinal number of the ownership tokens to be returned to the n-th cardinal number of the ownership tokens to be returned, and (iii-1-2-4) check whether the fifth hash value matches with the sixth hash value, to thereby verify the first buyer signature value to the n-th buyer signature value, and (iii-2) in response to verifying the first buyer signature value to the n-th buyer signature value, execute the ownership token contract, to thereby transfer the first cardinal number of the ownership tokens to be returned to the n-th cardinal number of the ownership tokens to be returned to the transaction server's digital wallet address.

As one example, the method further includes a step of: (e) the online transaction server, in response to collecting the ownership tokens from the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one seventh hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a third server signature value, and the first administrator termination signature value to the k-th administrator termination signature value, wherein the third server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the third server signature value and the first administrator termination signature value to the k-th administrator termination signature value, wherein the third server signature value is acquired by signing the seventh hash value with the transaction server private key, and wherein the seventh hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the third server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the third server signature value and the first administrator termination signature value to the k-th administrator termination signature value, or (iv-1-2) (iv-1-2-1) decrypt the third server signature value and the first administrator termination signature value to the k-th administrator termination signature value by using the transaction server public key and each of the public keys of the first administrator to the k-th administrator, (iv-2-2) acquire the seventh hash value as a result of said (iv-1-2-1), (iv-1-2-3) generate an eighth hash value by hashing at least one of the ownership token contract ID and the transaction server's digital wallet address, and (iv-1-2-4) check whether the seventh hash value matches with the eighth hash value, to thereby verify the third server signature value and the first administrator termination signature value to the k-th administrator termination signature value, and (iv-2) in response to verifying the third server signature value and the first administrator termination signature value to the k-th administrator termination signature value, execute the ownership token contract, to thereby terminate the ownership tokens transferred from the first buyer to the n-th buyer.

As one example, the method further includes a step of: (f) the online transaction server, in response to collecting specific ownership tokens from a specific buyer among the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one ninth hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a fourth server signature value, and the first administrator termination signature value to the k-th administrator termination signature value, wherein the fourth server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the fourth server signature value and the first administrator termination signature value to the k-th administrator termination signature value, wherein the fourth server signature value is acquired by signing the ninth hash value with the transaction server private key, and wherein the ninth hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the fourth server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the fourth server signature value and the first administrator termination signature value to the k-th administrator termination signature value, or (iv-1-2) (iv-1-2-1) decrypt the fourth server signature value and the first administrator termination signature value to the k-th administrator termination signature value by using the transaction server public key and each of the public keys of the first administrator to the k-th administrator, (iv-1-2-2) acquire the ninth hash value as a result of said (iv-1-2-1), (iv-1-2-3) generate a tenth hash value by hashing at least one of the ownership token contract ID and the transaction server's digital wallet address, and (iv-1-2-4) check whether the ninth hash value matches with the tenth hash value, to thereby verify the fourth server signature value and the first administrator termination signature value to the k-th administrator termination signature value, and (iv-2) in response to verifying the fourth server signature value and the first administrator termination signature value to the k-th administrator termination signature value, execute the ownership token contract, to thereby terminate the specific ownership tokens transferred from the specific buyer among first buyer to the n-th buyer.

In accordance to another aspect of the present disclosure, there is provided a method for distributing collectable ownership based on blockchain networks, including steps of: (a) an online transaction server, in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; (b) the online transaction server, in response to acquiring each piece of ownership distribution participation information for participating in an ownership distribution of the collectable from each of a first buyer to an n-th buyer, wherein n is an integer greater than or equal to 1, according to an ownership distribution participation request for the collectable registered to distribute the ownership of the collectable, (i) generating each of a first multi-signature wallet contract to an n-th multi-signature wallet contract in order to distribute ownership tokens to each of the first buyer to the n-th buyer, (ii) generating at least one multi-signature wallet contract registering transaction which includes each of the first multi-signature wallet contract to the n-th multi-signature wallet contract and a second server signature value, which is a signature value of the online transaction server, and (iii) broadcasting the at least one multi-signature wallet contract registering transaction to the blockchain network, to thereby instruct the blockchain nodes of the blockchain network to (iii-1) verify the second server signature value, (iii-2) in response to verifying the second server signature value, register the first multi-signature wallet contract to the n-th multi-signature wallet contract included in the multi-signature wallet contract registering transaction in the blockchain network, and (iii-3) transfer a first multi-signature wallet contract ID to an n-th multi-signature wallet contract ID corresponding to the first multi-signature wallet contract to the n-th multi-signature wallet contract registered in the blockchain network to the online transaction server; and (c) the online transaction server (i) generating an ownership transferal transaction which includes the ownership token contract ID, ownership transferal information acquired by referring to the ownership distribution participation information, and a third server signature value which is a signature value acquired by signing (i-1) at least one of the ownership token contract ID and the ownership transferal information with a transaction server private key of the online transaction server, or (i-2) at least one first hash value of at least one of the ownership token contract ID and the ownership transferal information, and (ii) broadcasting the ownership transferal transaction to the blockchain network, to thereby instruct the blockchain nodes of the blockchain network to (ii-1) verify the third server signature value, and (ii-2) in response to verifying the third server signature value, execute the ownership token contract corresponding to the ownership token contract ID and thus transfer each of the ownership tokens corresponding to the collectable to each of the first multi-signature wallet contract to the n-th multi-signature wallet contract corresponding to each of the first buyer to the n-th buyer who have participated in the ownership distribution according to the ownership transferal information.

As one example, at the step of (c), the online transaction server, in response to acquiring the ownership distribution participation information which includes first buyer distribution participation information to n-th buyer distribution participation information from the first buyer to the n-th buyer upon a completion of distributing the ownership of the collectable, (i) (i-1) broadcasts, to the blockchain network, the ownership transferal transaction which includes the ownership token contract ID, the ownership transferal information, and the third server signature value, wherein the ownership transferal information includes a first multi-signature wallet contract's address to an n-th multi-signature wallet contract's address and a first cardinal number of the ownership tokens to be transferred to an n-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, and the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract, to thereby transfer the first cardinal number of the ownership tokens to be transferred to the n-th cardinal number of the ownership tokens to be transferred respectively to the first multi-signature wallet contract's address to the n-th multi-signature wallet contract's address.

As one example, at the step of (c), the online transaction server, in response to acquiring the ownership distribution participation information which includes k-th buyer distribution participation information upon a partial completion of distributing the ownership of the collectable by a k-th buyer among the first buyer to the n-th buyer, (i) (i-1) broadcasts, to the blockchain network, the ownership transferal transaction which includes the ownership token contract ID, the ownership transferal information, and the third server signature value, wherein the ownership transferal information includes a k-th multi-signature wallet contract's address and a k-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract to transfer the k-th cardinal number of the ownership tokens to be transferred to the k-th multi-signature wallet contract's address, to thereby transfer the first cardinal number of the ownership tokens to be transferred to the n-th cardinal number of the ownership tokens to be transferred respectively to the first multi-signature wallet contract's address to the n-th multi-signature wallet contract's address.

As one example, the ownership token contract includes information on an ownership token structure and an ownership token function corresponding to the collectable, wherein the ownership token structure includes information on the collectable, information on an ownership token ID, and a cardinal number of issued ownership tokens, wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and wherein the ownership token function includes at least part of an ownership token transferal function, an ownership token termination function, an ownership token balance checking function, an ownership token transfer history tracking function, an ownership token restriction function, an ownership token lookup function, and an ownership token holder lookup function.

As one example, the method further includes steps of: (d1) the online transaction server (i) sending the ownership tokens to the first multi-signature wallet contract to the n-th multi-signature wallet contract through the blockchain network, to thereby allow a specific buyer among the first buyer to the n-th buyer who received an ownership token transferal request from a new buyer to (i-1) send an ownership token handover request corresponding to the ownership token transferal request to the online transaction server, (ii) in response to acquiring the ownership token handover request, generating a new multi-signature wallet contract in order to hand over the ownership tokens to the new buyer by referring to the ownership token handover request, (iii) generating a new multi-signature wallet contract registering transaction which includes the new multi-signature wallet contract and a fourth server signature value, which is a signature value of the online transaction server, and (iv) broadcasting the new multi-signature wallet contract registering transaction to the blockchain network, to thereby instruct the blockchain nodes to (iv-1) verify the fourth server signature value, (iv-2) in response to verifying the fourth server signature value, register the new multi-signature wallet contract included in the new multi-signature wallet contract registering transaction to the blockchain network, and (iv-3) transfer a new multi-signature wallet contract ID corresponding to the new multi-signature wallet contract registered in the blockchain network to the online transaction server; and (d2) the online transaction server (i) generating an ownership token transferal task submission transaction which includes the ownership token contract ID, a new multi-signature wallet contract's address, a new cardinal number of ownership tokens to be transferred, and a fifth server signature value which is acquired by signing (i-1) at least one of the ownership token contract ID, the new multi-signature wallet contract's address, and the new cardinal number of ownership tokens to be transferred with the transaction server private key, or (i-2) at least one third hash value of at least one of the ownership token contract ID, the new multi-signature wallet contract's address, and the new cardinal number of ownership tokens to be transferred with the transaction server private key, to thereby broadcast the ownership token transferal task submission transaction to the blockchain network, (ii) instructing the blockchain nodes to (ii-1) (ii-1-1) decrypt the fifth server signature value by using a transaction server public key of the online transaction server (ii-1-2) acquire at least one of the ownership token contract ID, the new multi-signature wallet contract's address, and the new cardinal number of ownership tokens to be transferred as a result of said (ii-1-1), and (ii-1-3) check whether the acquired at least one of the ownership token contract ID, the new multi-signature wallet contract's address, and the new cardinal number of ownership tokens to be transferred matches with at least one of the ownership token contract ID, the new multi-signature wallet contract's address, and the new cardinal number of ownership tokens to be transferred included in the ownership token transferal task submission transaction, to thereby verify the fifth server signature value, or (ii-2) (ii-2-1) decrypt the fifth server signature value by using the transaction server public key, (ii-2-2) acquire the third hash value as a result of said (ii-2-1), (ii-2-3) generate a fourth hash value by hashing at least one of the ownership token contract ID, the new multi-signature wallet contract's address, and the new cardinal number of ownership tokens to be transferred, and (ii-2-4) check whether the third hash value matches with the fourth hash value, to thereby verify the fifth server signature value, (iii) requesting each of a first multi-signer to an m-th multi-signer to multi-sign an ownership token transferal task submission transaction ID corresponding to the ownership token transferal task submission transaction, wherein m is an integer greater than or equal to 1, (iv) generating each of ownership token transferal task approval transactions which includes each of a first multi-signer transferal signature value to a j-th multi-signer transferal signature value and the ownership token transferal task submission transaction ID, wherein each of the first multi-signer transferal signature value to the j-th multi-signer transferal signature value is acquired by signing (iv-1) the ownership token transferal task submission transaction ID with each of multi-signer private keys of the first multi-signer to a j-th multi-signer, or (iv-2) a fifth hash value of the ownership token transferal task submission transaction ID with each of the multi-signer private keys of the first multi-signer to the j-th multi-signer, and wherein j is an integer greater than or equal to 1 and less than m, (v) sending each of the ownership token transferal task approval transactions from each of the first multi-signer to the j-th multi-signer to the blockchain network, and (vi) instructing the blockchain nodes to (vi-1) (vi-1-1) (vi-1-1-1) decrypt the first multi-signer transferal signature value to the j-th multi-signer transferal signature value by using each of multi-signature public keys of the first multi-signer to the j-th multi-signer, (vi-1-1-2) acquire the ownership token transferal task submission transaction ID as a result of said (vi-1-1-1) and, (vi-1-1-3) check whether the acquired ownership token transferal task submission transaction ID matches with the ownership token transferal task submission transaction ID included in each of the ownership token transferal task approval transactions, to thereby verify the first multi-signer transferal signature value to the j-th multi-signer transferal signature value, or (vi-1-2) (vi-1-2-1) decrypt the first multi-signer transferal signature value to the j-th multi-signer transferal signature value by using each of the multi-signature public keys, (vi-1-2-2) acquire the fifth hash value as a result of said (vi-1-2-1), (vi-1-2-3) generate a sixth hash value by hashing the ownership token transferal task submission transaction ID, and (vi-1-2-4) check whether the fifth hash value matches with the sixth hash value, to thereby verify the first multi-signer transferal signature value to the j-th multi-signer transferal signature value included in each of the ownership token transferal task approval transactions, and (vi-2) in response to verifying the fifth server signature value to be valid and in response to checking that a cardinal number of multi-signer transferal signature values verified to be valid among the first multi-signer transferal signature value to the j-th multi-signer transferal signature value is greater than a predetermined number, execute a specific multi-signature wallet contract corresponding to the specific buyer, to thereby transfer the new cardinal number of ownership tokens to be transferred to the new multi-signature wallet contract's address according to the ownership token contract.

As one example, the method further includes a step of: (e) the online transaction server, in response to acquiring sale completion information, (i) generating an ownership token termination task submission transaction which includes the ownership token contract ID and a sixth server signature value which is acquired by (i-1) signing the ownership token contract ID with a transaction server private key of the online transaction server or (i-2) signing a seventh hash value of the ownership token contract ID with the transaction server private key, to thereby broadcast the ownership token termination task submission transaction to the blockchain network, (ii) instructing the blockchain nodes to (ii-1) (ii-1-1) decrypt the sixth server signature value by using a transaction server public key of the online transaction server, (ii-1-2) acquire the ownership token contract ID as a result of said (ii-1-1), and (ii-1-3) check whether the acquired ownership token contract ID matches with the ownership token contract ID included in the ownership token termination task submission transaction, to thereby verify the sixth server signature value, or (ii-2) (ii-2-1) decrypt the sixth server signature value by using the transaction public key, (ii-2-2) acquire the seventh hash value as a result of (ii-2-1), (ii-2-3) generate an eighth hash value by hashing the ownership token contract ID, and (ii-2-4) check whether the seventh hash value matches with the eighth hash value, to thereby verify the sixth server signature value, (iii) requesting each of a first multi-signer to an m-th multi-signer to multi-sign an ownership token termination task submission transaction ID corresponding to the ownership token termination task submission transaction, wherein m is an integer greater than or equal to 1, (iv) generating each of ownership token termination task approval transactions which includes each of a first multi-signer termination signature value to a j-th multi-signer termination signature value and the ownership token termination task submission transaction ID, wherein each of the first multi-signer termination signature value to the j-th multi-signer termination signature value is acquired by signing (iv-1) the ownership token termination task submission transaction ID with each of multi-signer private keys of the first multi-signer to the j-th multi-signer, or (iv-2) a ninth hash value of the ownership token termination task submission transaction ID with each of the multi-signer private keys of the first multi-signer to the j-th multi-signer, and wherein j is an integer greater than or equal to 1 and less than m, (v) broadcasting each of the ownership token termination task approval transactions from each of the first multi-signer to the j-th multi-signer to the blockchain network, and (vi) instructing the blockchain nodes to (vi-1) (vi-1-1) (vi-1-1-1) decrypt the first multi-signer termination signature value to the j-th multi-signer termination signature value by using each of multi-signature public keys of the first multi-signer to the j-th multi-signer, (vi-1-1-2) acquire the ownership token termination task submission transaction ID as a result of said (vi-1-1-1) and, (vi-1-1-3) check whether the acquired ownership token termination task submission transaction ID matches with the ownership token termination task submission transaction ID included in each of the ownership token termination task approval transactions, to thereby verify the first multi-signer termination signature value to the j-th multi-signer termination signature value, or (vi-1-2) (vi-1-2-1) decrypt the first multi-signer termination signature value to the j-th multi-signer termination signature value by using each of the multi-signature public keys, (vi-1-2-2) acquire the ninth hash value as a result of said (vi-1-2-1), (vi-1-2-3) generate a tenth hash value by hashing the ownership token termination task submission transaction ID, and (vi-1-2-4) check whether the ninth hash value matches with the tenth hash value, to thereby verify each of the first multi-signer termination signature value to the j-th multi-signer termination signature value included in each of the ownership token termination task approval transactions, and (vi-2) in response to verifying the sixth server signature value to be valid and in response to checking that a cardinal number of multi-signer termination signature values verified to be valid among the first multi-signer termination signature value to the j-th multi-signer termination signature value is greater than or equal to a predetermined number, execute the first multi-signature wallet contract to the n-th multi-signature wallet contract, to thereby terminate the ownership tokens according to the ownership token contract.

As one example, each of the first multi-signature wallet contract to the n-th multi-signature wallet contract includes information on a multi-signature structure and a multi-signature function, wherein the multi-signature structure includes information on at least part of a cardinal number of people taking part in multi-signature, a minimum number of multi-signatures required to validate a multi-signature, and addresses of multi-signers, and wherein the multi-signature function includes at least part of an ownership token related task submission function, an ownership token related task approval function, an ownership token related task executing function, a multi-signer adding function, a multi-signer deleting function, and a number changing function for changing the minimum number of multi-signatures.

In accordance with still another aspect of the present disclosure, there is provided an online transaction server for distributing collectable ownership based on blockchain networks, including at least one memory that stores instructions; and at least one processor configured to execute the instructions to perform processes of: (1) in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; and (2) in response to acquiring each piece of ownership distribution participation information for participating in an ownership distribution of the collectable from each of a first buyer to an n-th buyer, wherein n is an integer equal to or larger than 1, according to an ownership distribution participation request for the collectable registered to distribute the ownership of the collectable, (i) requesting each of a first administrator to an m-th administrator, wherein m is an integer equal to or larger than 1, to sign at least one of the ownership token contract ID and ownership transferal information corresponding to the ownership distribution participation information, and (ii) in response to acquiring each of a first administrator signature value to a k-th administrator signature value, which is a signature value acquired by signing at least one of the ownership token contract ID and the ownership transferal information or at least one first hash value of at least one of the ownership token contract ID and the ownership transferal information with each of private keys from each of the first administrator to a k-th administrator, wherein k is an integer equal to or larger than 1 and equal to or less than m, (ii-1) generating an ownership transferal transaction which includes the ownership token contract ID, the ownership transferal information acquired by referring to the ownership distribution participation information, a second server signature value, which is a signature value of the online transaction server, and the first administrator signature value to the k-th administrator signature value, and (ii-2) broadcasting the ownership transferal transaction to the blockchain network, to thereby instruct the blockchain nodes of the blockchain network to (ii-2-1) verify the second server signature value and the first administrator signature value to the k-th administrator signature value, and (ii-2-2) in response to verifying the second server signature value and the first administrator signature value to the k-th administrator signature value, execute the ownership token contract corresponding to the ownership token contract ID and thus transfer ownership tokens corresponding to the collectable to the first buyer to the n-th buyer who have participated in the ownership distribution according to the ownership transferal information.

As one example, at the process of (2), the processor, in response to acquiring the ownership distribution participation information which includes first buyer distribution participation information and n-th buyer distribution participation information from the first buyer to the n-th buyer upon a completion of distributing the ownership of the collectable, (i) requests each of the first administrator to the m-th administrator to sign at least one of the ownership token contract ID and the ownership transferal information, wherein the ownership transferal information includes a first buyer's digital wallet address to an n-th buyer's digital wallet address and a first cardinal number of the ownership tokens to be transferred to an n-th cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the first cardinal number of the ownership tokens to be transferred to the n-th cardinal number of the ownership tokens to be transferred respectively to the first buyer's digital wallet address to the n-th buyer's digital wallet address.

As one example, at the process of (2), the processor, in response to acquiring the ownership distribution participation information which includes specific buyer distribution participation information upon a partial completion of distributing the ownership of the collectable by a specific buyer among the first buyer to the n-th buyer, (i) requests each of the first administrator to the m-th administrator to sign at least one of the ownership token contract ID and the ownership transferal information, wherein the ownership transferal information includes a specific buyer's digital wallet address and a specific cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the specific cardinal number of the ownership tokens to be transferred to the specific digital wallet address.

As one example, the ownership token contract includes information on an ownership token structure and an ownership token function corresponding to the collectable, wherein the ownership token structure includes information on the collectable, information on an ownership token ID, and a cardinal number of issued ownership tokens, wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and wherein the ownership token function includes at least part of an ownership token transferal function, an ownership token termination function, an ownership token balance checking function, an ownership token transfer history tracking function, an ownership token restriction function, an ownership token lookup function, an ownership token holder lookup function, an administrator address registering function, and a multi-signature values verifying function.

As one example, the processor further performs a process of: (3) (i) allowing transferring of the ownership tokens to the first buyer to the n-th buyer through the blockchain network, (ii) allowing a specific buyer among the first buyer to the n-th buyer who received an ownership token transferal request from a new buyer to (ii-1) generate an ownership token transferal transaction which includes the ownership token contract ID, a new buyer's digital wallet address, a new cardinal number of the ownership tokens to be transferred, and a specific buyer signature value which is acquired by signing (ii-1-1) at least one of the ownership token contract ID, the new buyer's digital wallet address, and the new cardinal number of the ownership tokens to be transferred with a specific buyer private key of the specific buyer, or (ii-1-2) at least one third hash value of at least one of the ownership token contract ID, the new buyer's digital wallet address, and the new cardinal number of ownership tokens to be transferred with the specific buyer private key of the specific buyer, (ii-2) request the online transaction server to multi-sign (ii-2-1) at least one of the ownership token contract ID, the new buyer's digital wallet address, and the new cardinal number of the ownership tokens to be transferred with each of the private keys from each of the first administrator to the k-th administrator, or (ii-2-2) the third hash value of at least one of the ownership token contract ID, the new buyer's digital wallet address, and the new cardinal number of ownership tokens to be transferred with each of the private keys from each of the first administrator to the k-th administrator, to thereby acquire multi-signature values which include a first administrator transferal signature value to a k-th administrator transferal signature value from the first administrator to the k-th administrator, and thus (ii-3) broadcast an ownership token transferal request, which includes the ownership token transferal transaction and the multi-signature values, to the blockchain network, and (iii) instructing the blockchain nodes which received the ownership token transferal request to (iii-1) (iii-1-1) (iii-1-1-1) decrypt the specific buyer signature value and the first administrator transferal signature value to the k-th administrator transferal signature value by using a specific buyer public key of the specific buyer and each of the public keys of the first administrator to the k-th administrator, (iii-1-1-2) acquire at least one of the ownership token contract ID, the new buyer's digital wallet address and the new cardinal number of the ownership tokens to be transferred as a result of said (iii-1-1-1), and (iii-1-1-3) check whether the acquired at least one of the ownership token contract ID, the new buyer's digital wallet address, and the new cardinal number of the ownership tokens to be transferred matches with the at least one of the ownership token contract ID, the new buyer's digital wallet address, and the new cardinal number of the ownership tokens to be transferred included in the ownership token transferal request, to thereby verify the specific buyer signature value and the first administrator transferal signature value to the k-th administrator transferal signature value, or (iii-1-2) (iii-1-2-1) decrypt the specific buyer signature value and the first administrator transferal signature value to the k-th administrator transferal signature value by using the specific buyer public key of the specific buyer and each of the public keys of the first administrator to the k-th administrator, (iii-1-2-2) acquire the third hash value as a result of said (iii-1-2-1), (iii-1-2-3) generate a fourth hash value by hashing at least one of the ownership token contract ID, the new buyer's digital wallet address, and the new cardinal number of the ownership tokens to be transferred, and (iii-1-2-4) check whether the third hash value matches with the fourth hash value, to thereby verify the specific buyer signature value and the first administrator transferal signature value to the k-th administrator transferal signature value, and (iii-2) in response to verifying the specific buyer signature value and the first administrator transferal signature value to the k-th administrator transferal signature value, execute the ownership token contract, to thereby transfer the new cardinal number of the ownership tokens to be transferred to the new buyer's digital wallet address.

As one example, the processor of the online transaction server further performs a process of: (4) in response to acquiring sale completion information, (i) sending an ownership token collection request to the first buyer to the n-th buyer for liquidating the ownership tokens corresponding to the collectable, (ii) allowing the first buyer to the n-th buyer to (ii-1) generate each of a first ownership token return transaction to an n-th ownership token return transaction which includes the ownership token contract ID, a transaction server's digital wallet address corresponding to the online transaction server, a first cardinal number of the ownership tokens to be returned to an n-th cardinal number of the ownership tokens to be returned, and each of a first buyer signature value to an n-th buyer signature value which is acquired by signing at least one of the ownership token contract ID, the transaction server's digital wallet address, the first cardinal number of the ownership tokens to be returned to the n-th cardinal number of the ownership tokens to be returned with each of a first buyer private key to an n-th buyer private key corresponding to each of the first buyer to the n-th buyer, to thereby broadcast the first ownership token return transaction to the n-th ownership token return transaction to the blockchain network, or (ii-2) generate each of the first ownership token return transaction to the n-th ownership token return transaction which includes the ownership token contract ID, the transaction server's digital wallet address, the first cardinal number of the ownership tokens to be returned to the n-th cardinal number of the ownership tokens to be returned, and each of the first buyer signature value to the n-th buyer signature value which is acquired by signing a fifth hash value with each of the first buyer private key to the n-th buyer private key, wherein the fifth hash value is acquired by hashing at least one of the ownership token contract ID, the transaction server's digital wallet address, and the first cardinal number of the ownership tokens to be returned to the n-th cardinal number of the ownership tokens to be returned, to thereby broadcast the first ownership token return transaction to the n-th ownership token return transaction to the blockchain network, and (iii) instructing the blockchain nodes to (iii-1) (iii-1-1) (iii-1-1-1) decrypt the first buyer signature value to the n-th buyer signature value by using the first buyer public key to the n-th buyer public key corresponding to the first buyer to the n-th buyer, (iii-1-1-2) acquire at least one of the ownership token contract ID, the transaction server's digital wallet address, and the first cardinal number of the ownership tokens to be returned to the n-th cardinal number of the ownership tokens to be returned as a result of said (iii-1-1-2), and (iii-1-1-3) check whether the acquired at least one of the ownership token contract ID, the transaction server's digital wallet address, and the first cardinal number of the ownership tokens to be returned to the n-th cardinal number of the ownership tokens to be returned matches with at least one of the ownership token contract ID, the transaction server's digital wallet address, and the first cardinal number of the ownership tokens to be returned to the n-th cardinal number of the ownership tokens to be returned included in the first ownership token return transaction to the n-th ownership token return transaction, to thereby verify the first buyer signature value to the n-th buyer signature value, or (iii-1-2) (iii-1-2-1) decrypt the first buyer signature value to the n-th buyer signature value by using the first buyer public key to the n-th buyer public key, (iii-1-2-2) acquire the fifth hash value as a result of said (iii-1-2-1), (iii-1-2-3) generate a sixth hash value by hashing at least one of the ownership token contract ID, the transaction server's digital wallet address, and the first cardinal number of the ownership tokens to be returned to the n-th cardinal number of the ownership tokens to be returned, and (iii-1-2-4) check whether the fifth hash value matches with the sixth hash value, to thereby verify the first buyer signature value to the n-th buyer signature value, and (iii-2) in response to verifying the first buyer signature value to the n-th buyer signature value, execute the ownership token contract, to thereby transfer the first cardinal number of the ownership tokens to be returned to the n-th cardinal number of the ownership tokens to be returned to the transaction server's digital wallet address.

As one example, the processor of the online transaction server further performs a process of: (5) in response to collecting the ownership tokens from the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one seventh hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a third server signature value, and the first administrator termination signature value to the k-th administrator termination signature value, wherein the third server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the third server signature value and the first administrator termination signature value to the k-th administrator termination signature value, wherein the third server signature value is acquired by signing the seventh hash value with the transaction server private key, and wherein the seventh hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the third server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the third server signature value and the first administrator termination signature value to the k-th administrator termination signature value, or (iv-1-2) (iv-1-2-1) decrypt the third server signature value and the first administrator termination signature value to the k-th administrator termination signature value by using the transaction server public key and each of the public keys of the first administrator to the k-th administrator, (iv-2-2) acquire the seventh hash value as a result of said (iv-1-2-1), (iv-1-2-3) generate an eighth hash value by hashing at least one of the ownership token contract ID and the transaction server's digital wallet address, and (iv-1-2-4) check whether the seventh hash value matches with the eighth hash value, to thereby verify the third server signature value and the first administrator termination signature value to the k-th administrator termination signature value, and (iv-2) in response to verifying the third server signature value and the first administrator termination signature value to the k-th administrator termination signature value, execute the ownership token contract, to thereby terminate the ownership tokens transferred from the first buyer to the n-th buyer.

As one example, the processor of the online transaction server further performs a process of: (6) in response to collecting specific ownership tokens from a specific buyer among the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one ninth hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a fourth server signature value, and the first administrator termination signature value to the k-th administrator termination signature value, wherein the fourth server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the fourth server signature value and the first administrator termination signature value to the k-th administrator termination signature value, wherein the fourth server signature value is acquired by signing the ninth hash value with the transaction server private key, and wherein the ninth hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the fourth server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the fourth server signature value and the first administrator termination signature value to the k-th administrator termination signature value, or (iv-1-2) (iv-1-2-1) decrypt the fourth server signature value and the first administrator termination signature value to the k-th administrator termination signature value by using the transaction server public key and each of the public keys of the first administrator to the k-th administrator, (iv-1-2-2) acquire the ninth hash value as a result of said (iv-1-2-1), (iv-1-2-3) generate a tenth hash value by hashing at least one of the ownership token contract ID and the transaction server's digital wallet address, and (iv-1-2-4) check whether the ninth hash value matches with the tenth hash value, to thereby verify the fourth server signature value and the first administrator termination signature value to the k-th administrator termination signature value, and (iv-2) in response to verifying the fourth server signature value and the first administrator termination signature value to the k-th administrator termination signature value, execute the ownership token contract, to thereby terminate the specific ownership tokens transferred from the specific buyer among first buyer to the n-th buyer.

In accordance with still yet another aspect of the present disclosure, there is provided an online transaction server for distributing collectable ownership based on blockchain networks, including at least one memory that stores instructions; and at least one processor configured to execute the instructions to perform processes of: (1) in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; (b) the online transaction server, in response to acquiring each piece of ownership distribution participation information for participating in an ownership distribution of the collectable from each of a first buyer to an n-th buyer, wherein n is an integer greater than or equal to 1, according to an ownership distribution participation request for the collectable registered to distribute the ownership of the collectable, (i) generating each of a first multi-signature wallet contract to an n-th multi-signature wallet contract in order to distribute ownership tokens to each of the first buyer to the n-th buyer, (ii) generating at least one multi-signature wallet contract registering transaction which includes each of the first multi-signature wallet contract to the n-th multi-signature wallet contract and a second server signature value, which is a signature value of the online transaction server, and (iii) broadcasting the at least one multi-signature wallet contract registering transaction to the blockchain network, to thereby instruct the blockchain nodes of the blockchain network to (iii-1) verify the second server signature value, (iii-2) in response to verifying the second server signature value, register the first multi-signature wallet contract to the n-th multi-signature wallet contract included in the multi-signature wallet contract registering transaction in the blockchain network, and (iii-3) transfer a first multi-signature wallet contract ID to an n-th multi-signature wallet contract ID corresponding to the first multi-signature wallet contract to the n-th multi-signature wallet contract registered in the blockchain network to the online transaction server; and (3) the online transaction server (i) generating an ownership transferal transaction which includes the ownership token contract ID, ownership transferal information acquired by referring to the ownership distribution participation information, and a third server signature value which is a signature value acquired by signing (i-1) at least one of the ownership token contract ID and the ownership transferal information with a transaction server private key of the online transaction server, or (i-2) at least one first hash value of at least one of the ownership token contract ID and the ownership transferal information, and (ii) broadcasting the ownership transferal transaction to the blockchain network, to thereby instruct the blockchain nodes of the blockchain network to (ii-1) verify the third server signature value, and (ii-2) in response to verifying the third server signature value, execute the ownership token contract corresponding to the ownership token contract ID and thus transfer each of the ownership tokens corresponding to the collectable to each of the first multi-signature wallet contract to the n-th multi-signature wallet contract corresponding to each of the first buyer to the n-th buyer who have participated in the ownership distribution according to the ownership transferal information.

As one example, at the process of (3), the processor, in response to acquiring the ownership distribution participation information which includes first buyer distribution participation information to n-th buyer distribution participation information from the first buyer to the n-th buyer upon a completion of distributing the ownership of the collectable, (i) (i-1) broadcasts, to the blockchain network, the ownership transferal transaction which includes the ownership token contract ID, the ownership transferal information, and the third server signature value, wherein the ownership transferal information includes a first multi-signature wallet contract's address to an n-th multi-signature wallet contract's address and a first cardinal number of the ownership tokens to be transferred to an n-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, and the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract, to thereby transfer the first cardinal number of the ownership tokens to be transferred to the n-th cardinal number of the ownership tokens to be transferred respectively to the first multi-signature wallet contract's address to the n-th multi-signature wallet contract's address.

As one example, at the process of (3), the processor, in response to acquiring the ownership distribution participation information which includes k-th buyer distribution participation information upon a partial completion of distributing the ownership of the collectable by a k-th buyer among the first buyer to the n-th buyer, (i) (i-1) broadcasts, to the blockchain network, the ownership transferal transaction which includes the ownership token contract ID, the ownership transferal information, and the third server signature value, wherein the ownership transferal information includes a k-th multi-signature wallet contract's address and a k-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract to transfer the k-th cardinal number of the ownership tokens to be transferred to the k-th multi-signature wallet contract's address, to thereby transfer the first cardinal number of the ownership tokens to be transferred to the n-th cardinal number of the ownership tokens to be transferred respectively to the first multi-signature wallet contract's address to the n-th multi-signature wallet contract's address.

As one example, the ownership token contract includes information on an ownership token structure and an ownership token function corresponding to the collectable, wherein the ownership token structure includes information on the collectable, information on an ownership token ID, and a cardinal number of issued ownership tokens, wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and wherein the ownership token function includes at least part of an ownership token transferal function, an ownership token termination function, an ownership token balance checking function, an ownership token transfer history tracking function, an ownership token restriction function, an ownership token lookup function, and an ownership token holder lookup function.

As one example, the processor of the online transaction server further performs a process of: (4-1) (i) sending the ownership tokens to the first multi-signature wallet contract to the n-th multi-signature wallet contract through the blockchain network, to thereby allow a specific buyer among the first buyer to the n-th buyer who received an ownership token transferal request from a new buyer to (i-1) send an ownership token handover request corresponding to the ownership token transferal request to the online transaction server, (ii) in response to acquiring the ownership token handover request, generating a new multi-signature wallet contract in order to hand over the ownership tokens to the new buyer by referring to the ownership token handover request, (iii) generating a new multi-signature wallet contract registering transaction which includes the new multi-signature wallet contract and a fourth server signature value, which is a signature value of the online transaction server, and (iv) broadcasting the new multi-signature wallet contract registering transaction to the blockchain network, to thereby instruct the blockchain nodes to (iv-1) verify the fourth server signature value, (iv-2) in response to verifying the fourth server signature value, register the new multi-signature wallet contract included in the new multi-signature wallet contract registering transaction to the blockchain network, and (iv-3) transfer a new multi-signature wallet contract ID corresponding to the new multi-signature wallet contract registered in the blockchain network to the online transaction server; and (4-2) the online transaction server (i) generating an ownership token transferal task submission transaction which includes the ownership token contract ID, a new multi-signature wallet contract's address, a new cardinal number of ownership tokens to be transferred, and a fifth server signature value which is acquired by signing (i-1) at least one of the ownership token contract ID, the new multi-signature wallet contract's address, and the new cardinal number of ownership tokens to be transferred with the transaction server private key, or (i-2) at least one third hash value of at least one of the ownership token contract ID, the new multi-signature wallet contract's address, and the new cardinal number of ownership tokens to be transferred with the transaction server private key, to thereby broadcast the ownership token transferal task submission transaction to the blockchain network, (ii) instructing the blockchain nodes to (ii-1) (ii-1-1) decrypt the fifth server signature value by using a transaction server public key of the online transaction server (ii-1-2) acquire at least one of the ownership token contract ID, the new multi-signature wallet contract's address, and the new cardinal number of ownership tokens to be transferred as a result of said (ii-1-1), and (ii-1-3) check whether the acquired at least one of the ownership token contract ID, the new multi-signature wallet contract's address, and the new cardinal number of ownership tokens to be transferred matches with at least one of the ownership token contract ID, the new multi-signature wallet contract's address, and the new cardinal number of ownership tokens to be transferred included in the ownership token transferal task submission transaction, to thereby verify the fifth server signature value, or (ii-2) (ii-2-1) decrypt the fifth server signature value by using the transaction server public key, (ii-2-2) acquire the third hash value as a result of said (ii-2-1), (ii-2-3) generate a fourth hash value by hashing at least one of the ownership token contract ID, the new multi-signature wallet contract's address, and the new cardinal number of ownership tokens to be transferred, and (ii-2-4) check whether the third hash value matches with the fourth hash value, to thereby verify the fifth server signature value, (iii) requesting each of a first multi-signer to an m-th multi-signer to multi-sign an ownership token transferal task submission transaction ID corresponding to the ownership token transferal task submission transaction, wherein m is an integer greater than or equal to 1, (iv) generating each of ownership token transferal task approval transactions which includes each of a first multi-signer transferal signature value to a j-th multi-signer transferal signature value and the ownership token transferal task submission transaction ID, wherein each of the first multi-signer transferal signature value to the j-th multi-signer transferal signature value is acquired by signing (iv-1) the ownership token transferal task submission transaction ID with each of multi-signer private keys of the first multi-signer to a j-th multi-signer, or (iv-2) a fifth hash value of the ownership token transferal task submission transaction ID with each of the multi-signer private keys of the first multi-signer to the j-th multi-signer, and wherein j is an integer greater than or equal to 1 and less than m, (v) sending each of the ownership token transferal task approval transactions from each of the first multi-signer to the j-th multi-signer to the blockchain network, and (vi) instructing the blockchain nodes to (vi-1) (vi-1-1) (vi-1-1-1) decrypt the first multi-signer transferal signature value to the j-th multi-signer transferal signature value by using each of multi-signature public keys of the first multi-signer to the j-th multi-signer, (vi-1-1-2) acquire the ownership token transferal task submission transaction ID as a result of said (vi-1-1-1) and, (vi-1-1-3) check whether the acquired ownership token transferal task submission transaction ID matches with the ownership token transferal task submission transaction ID included in each of the ownership token transferal task approval transactions, to thereby verify the first multi-signer transferal signature value to the j-th multi-signer transferal signature value, or (vi-1-2) (vi-1-2-1) decrypt the first multi-signer transferal signature value to the j-th multi-signer transferal signature value by using each of the multi-signature public keys, (vi-1-2-2) acquire the fifth hash value as a result of said (vi-1-2-1), (vi-1-2-3) generate a sixth hash value by hashing the ownership token transferal task submission transaction ID, and (vi-1-2-4) check whether the fifth hash value matches with the sixth hash value, to thereby verify the first multi-signer transferal signature value to the j-th multi-signer transferal signature value included in each of the ownership token transferal task approval transactions, and (vi-2) in response to verifying the fifth server signature value to be valid and in response to checking that a cardinal number of multi-signer transferal signature values verified to be valid among the first multi-signer transferal signature value to the j-th multi-signer transferal signature value is greater than a predetermined number, execute a specific multi-signature wallet contract corresponding to the specific buyer, to thereby transfer the new cardinal number of ownership tokens to be transferred to the new multi-signature wallet contract's address according to the ownership token contract.

As one example, the processor of the online transaction server further performs a process of: (5) in response to acquiring sale completion information, (i) generating an ownership token termination task submission transaction which includes the ownership token contract ID and a sixth server signature value which is acquired by (i-1) signing the ownership token contract ID with a transaction server private key of the online transaction server or (i-2) signing a seventh hash value of the ownership token contract ID with the transaction server private key, to thereby broadcast the ownership token termination task submission transaction to the blockchain network, (ii) instructing the blockchain nodes to (ii-1) (ii-1-1) decrypt the sixth server signature value by using a transaction server public key of the online transaction server, (ii-1-2) acquire the ownership token contract ID as a result of said (ii-1-1), and (ii-1-3) check whether the acquired ownership token contract ID matches with the ownership token contract ID included in the ownership token termination task submission transaction, to thereby verify the sixth server signature value, or (ii-2) (ii-2-1) decrypt the sixth server signature value by using the transaction public key, (ii-2-2) acquire the seventh hash value as a result of (ii-2-1), (ii-2-3) generate an eighth hash value by hashing the ownership token contract ID, and (ii-2-4) check whether the seventh hash value matches with the eighth hash value, to thereby verify the sixth server signature value, (iii) requesting each of a first multi-signer to an m-th multi-signer to multi-sign an ownership token termination task submission transaction ID corresponding to the ownership token termination task submission transaction, wherein m is an integer greater than or equal to 1, (iv) generating each of ownership token termination task approval transactions which includes each of a first multi-signer termination signature value to a j-th multi-signer termination signature value and the ownership token termination task submission transaction ID, wherein each of the first multi-signer termination signature value to the j-th multi-signer termination signature value is acquired by signing (iv-1) the ownership token termination task submission transaction ID with each of multi-signer private keys of the first multi-signer to the j-th multi-signer, or (iv-2) a ninth hash value of the ownership token termination task submission transaction ID with each of the multi-signer private keys of the first multi-signer to the j-th multi-signer, and wherein j is an integer greater than or equal to 1 and less than m, (v) broadcasting each of the ownership token termination task approval transactions from each of the first multi-signer to the j-th multi-signer to the blockchain network, and (vi) instructing the blockchain nodes to (vi-1) (vi-1-1) (vi-1-1-1) decrypt the first multi-signer termination signature value to the j-th multi-signer termination signature value by using each of multi-signature public keys of the first multi-signer to the j-th multi-signer, (vi-1-1-2) acquire the ownership token termination task submission transaction ID as a result of said (vi-1-1-1) and, (vi-1-1-3) check whether the acquired ownership token termination task submission transaction ID matches with the ownership token termination task submission transaction ID included in each of the ownership token termination task approval transactions, to thereby verify the first multi-signer termination signature value to the j-th multi-signer termination signature value, or (vi-1-2) (vi-1-2-1) decrypt the first multi-signer termination signature value to the j-th multi-signer termination signature value by using each of the multi-signature public keys, (vi-1-2-2) acquire the ninth hash value as a result of said (vi-1-2-1), (vi-1-2-3) generate a tenth hash value by hashing the ownership token termination task submission transaction ID, and (vi-1-2-4) check whether the ninth hash value matches with the tenth hash value, to thereby verify each of the first multi-signer termination signature value to the j-th multi-signer termination signature value included in each of the ownership token termination task approval transactions, and (vi-2) in response to verifying the sixth server signature value to be valid and in response to checking that a cardinal number of multi-signer termination signature values verified to be valid among the first multi-signer termination signature value to the j-th multi-signer termination signature value is greater than or equal to a predetermined number, execute the first multi-signature wallet contract to the n-th multi-signature wallet contract, to thereby terminate the ownership tokens according to the ownership token contract.

As one example, each of the first multi-signature wallet contract to the n-th multi-signature wallet contract includes information on a multi-signature structure and a multi-signature function, wherein the multi-signature structure includes information on at least part of a cardinal number of people taking part in multi-signature, a minimum number of multi-signatures required to validate a multi-signature, and addresses of multi-signers, and wherein the multi-signature function includes at least part of an ownership token related task submission function, an ownership token related task approval function, an ownership token related task executing function, a multi-signer adding function, a multi-signer deleting function, and a number changing function for changing the minimum number of multi-signatures.

### BRIEF DESCRIPTION OF THE DRAWINGS

The following drawings to be used for explaining example embodiments of the present disclosure are only part of example embodiments of the present disclosure and other drawings can be acquired based on the drawings by those skilled in the art of the present disclosure without inventive work

FIG. 1 is a drawing schematically illustrating an online transaction server which distributes a collectable ownership based on a token corresponding to a collectable on a blockchain network in accordance with one example embodiment of the present disclosure.

FIG. 2 is a drawing schematically illustrating a method for distributing the collectable ownership based on the blockchain network in accordance with one example embodiment of the present disclosure.

FIG. 3 is a drawing schematically illustrating a method for transferring ownership tokens corresponding to the collectable based on the blockchain network in accordance with one example embodiment of the present disclosure.

FIG. 4 is a drawing schematically illustrating a method for collecting the ownership tokens corresponding to the collectable based on the blockchain network in accordance with one example embodiment of the present disclosure.

FIG. 5 is a drawing schematically illustrating a method for terminating the ownership tokens corresponding to the collectable based on the blockchain network in accordance with one example embodiment of the present disclosure.

FIG. 6 is a drawing schematically illustrating the method for distributing the collectable ownership based on the blockchain network in accordance with another example embodiment of the present disclosure.

FIG. 7 is a drawing schematically illustrating the method for transferring ownership tokens corresponding to a collectable based on the blockchain network in accordance with another example embodiment of the present disclosure.

FIG. 8 is a drawing schematically illustrating the method for terminating the ownership tokens corresponding to the collectable based on the blockchain network in accordance with another example embodiment of the present disclosure.

### DETAILED DESCRIPTION OF THE PREFERRED EMBODIMENTS

Detailed explanation on the present disclosure to be made below refer to attached drawings and diagrams illustrated as specific embodiment examples under which the present disclosure may be implemented to make clear of purposes, technical solutions, and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to those skilled in the art, partially from the specification and partially from the implementation of the present disclosure. The following examples and drawings will be provided as examples but they are not intended to limit the present disclosure.

Moreover, the present disclosure covers all possible combinations of example embodiments indicated in this specification. It is to be understood that the various embodiments of the present disclosure, although different, are not necessarily mutually exclusive. It is to be understood that the various embodiments of the present disclosure, although different, are not necessarily mutually exclusive. In addition, it is to be understood that the position or arrangement of individual elements within each disclosed embodiment may be modified without departing from the spirit and scope of the present disclosure. In addition, it is to be understood that the position or arrangement of individual elements within each disclosed embodiment may be modified without departing from the spirit and scope of the present disclosure. In the drawings, like numerals refer to the same or similar functionality throughout the several views.

To allow those skilled in the art to the present disclosure to be carried out easily, the example embodiments of the present disclosure by referring to attached diagrams will be explained in detail as shown below.

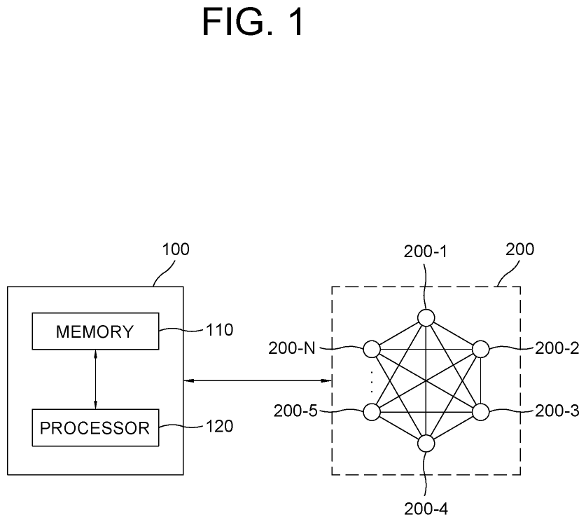

By referring to FIG. 1, the online server 100 includes a memory 110 which stores instructions for distributing a collectable ownership based on the blockchain network 200 and a processor 120 which distributes the collectable ownership based on tokens related to the collectable according to the instructions stored in the memory 110. Herein, the online transaction server 100 may include a PC (Personal Computer), a mobile computer, a PDA/EDA, a mobile phone, a smart phone, a tablet, an IoT device, etc. And, the online transaction server 100 is not limited thereto, and may include any mobile device like a digital camera, a personal navigation device, and a mobile gaming device, etc. capable of wired and wireless communication.

Specifically, the online transaction server 100 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

Also, the processors of such devices may include hardware configuration of MPU (Micro Processing Unit) or CPU (Central Processing Unit), cache memory, data bus, etc. Additionally, the computing device may further include operating system (OS) and software configuration of applications that achieve specific purposes.

Such description of the computing device does not exclude an integrated device including any combination of a processor, a memory, a medium, or any other computing components for implementing the present disclosure.

Further, the online transaction server 100 may be a server corresponding to at least one blockchain node of the blockchain network 200 or may be a server managing the blockchain node.

Herein, the blockchain network 200 may include one or more blockchain nodes 200-1, 200-2, . . . , 200-n, and each of the blockchain nodes 200-1, 200-2, . . . , 200-n may be a computing device including at least one memory and at least one processor.

Herein, the memory of the computing device may store the instructions. Specifically, the instructions are computer softwares which enable the blockchain nodes of the blockchain network 200 to perform in a certain way, and may be stored in a computer-usable or computer-readable memory. The instructions may execute processes for performing functions described in Figures.

Also, the processors of such devices may include hardware configuration of MPU (Micro Processing Unit) or CPU (Central Processing Unit), cache memory, data bus, etc. Additionally, the computing device may further include operating system (OS) and software configuration of applications that achieve specific purposes.

Such description of the computing device does not exclude an integrated device including any combination of a processor, a memory, a medium, or any other computing components for implementing the present disclosure.

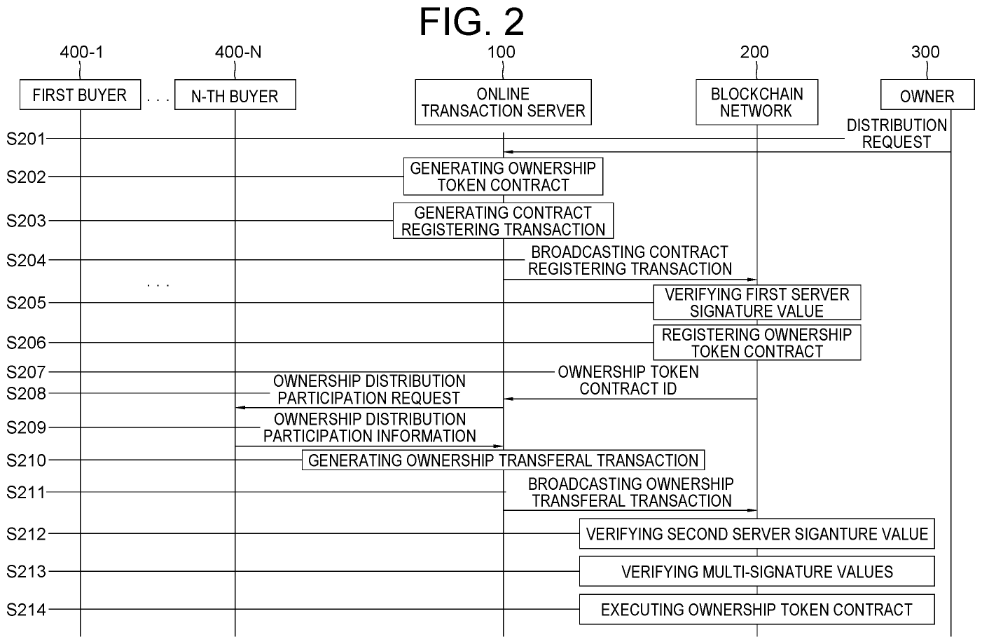

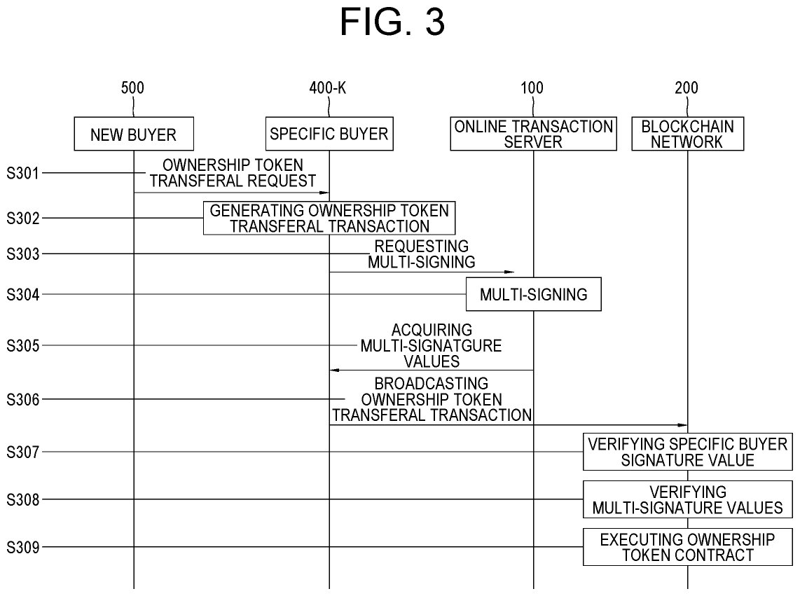

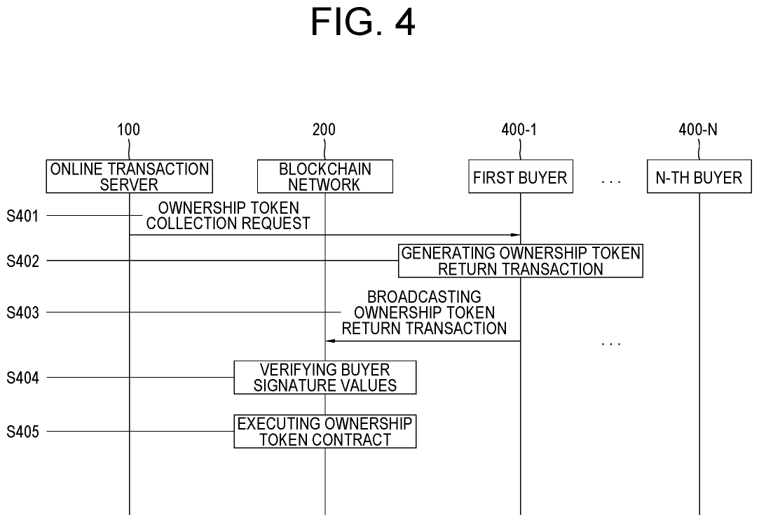

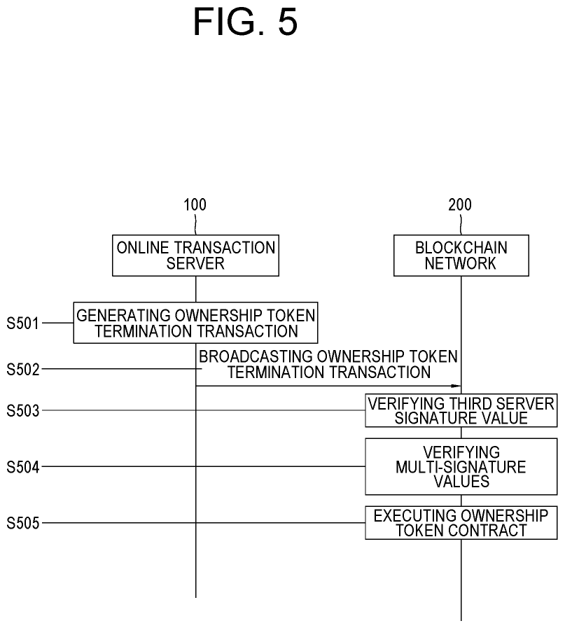

Processes for distributing the collectable ownership by the online transaction server 100 and the blockchain network 200 configured as above will be described below with reference to FIGS. 2 to 5.

First, in response to acquiring a distribution request for a collectable from an owner 300 who owns the collectable at a step of S201, the online transaction server 100 may generate an ownership token contract for distributing the collectable ownership at a step of S202. Herein, the owner 300 represents a person who owns the collectable or an owner device corresponding to the person who owns the collectable.

Herein, the owner 300 may send the collectable to a service provider who provides a service of online transaction to allow the service provider to inspect the collectable, and when an inspection is completed, the service provider may generate the ownership token contract corresponding to the collectable.

Herein, the ownership token contract may include information on an ownership token structure and information on an ownership token function corresponding to the collectable.

Specifically, the ownership token structure may include information on the collectable, information on an ownership token ID, and a cardinal number of issued ownership tokens.

Herein, the information on the collectable may be an ownership token name, and may include information on a content related to a collectable ownership token. More specifically, the information on the collectable may include at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, but it is not limited thereto.

In addition, a total number of issuable tokens, or a maximum number of buyable tokens per person may be determined according to one or more conditions such as a type of the collectable.

Further, the ownership tokens may be considered as assets for reflecting information on a shared ownership.

Furthermore, the ownership token ID may be an ownership token symbol, and may include ID information representing the ownership tokens.

Moreover, the ownership token function may include at least part of an ownership token transferal function, an ownership token termination function, an ownership token balance checking function, an ownership token transfer history tracking function, an ownership token restriction function, an ownership token lookup function, an ownership token holder lookup function, an administrator address registering function, and a multi-signature values verifying function, but it is not limited thereto.

In addition, the online transaction server 100 may (i) generate a contract registering transaction which includes the ownership token contract and a first server signature value, which is a signature value of the online transaction server 100, at a step of S203, and (ii) broadcast the contract registering transaction to the blockchain network 200, at a step of S204, to thereby instruct the blockchain nodes 200-1, 200-2, . . . , 200-n of the blockchain network 200 to (ii-1) verify the first server signature value, at a step of S205 (ii-2) in response to verifying the first server signature value, register the ownership token contract, included in the contract registering transaction, in the blockchain network 200, at a step of S206, and (ii-3) transfer an ownership token contract ID corresponding to the ownership token contract registered in the blockchain network 200 to the online transaction server 100, at a step of S207.

Herein, a transaction server public key of the online transaction server 100 should be registered in the blockchain network 200 in order to allow signature values of the online transaction sever 100, e.g., the first server signature value, to be verified by the blockchain nodes 200-1, 200-2, . . . , 200-n.

Further, the online transaction server 100 may allow the transaction server public key to be included in each of transactions generated by the online transaction server 100, to thereby instruct the blockchain nodes 200-1, 200-2, . . . , 200-n to acquire the transaction server public key from the transactions.

Furthermore, the online transaction server 100 may generate the first server signature value by electronically signing the ownership token contract with a transaction server private key of the online transaction server 100, but it is not limited thereto. For instance, the contract registering transaction may further include a nonce generated by the online transaction server 100, and the online transaction server 100 may generate the first server signature value by electronically signing the nonce by using the transaction server private key of the online transaction server 100.

Additionally, the ownership token contract ID may include an ownership token contract address.

For reference, other signature values of the online transaction server 100 and signature values of a first buyer 400-1 to an n-th buyer 400-n may also be generated by performing similar processes as described above, and therefore detailed descriptions thereon will be omitted.

Further, according to an ownership distribution participation request for the collectable at a step of S208, each piece of ownership distribution participation information for participating in an ownership distribution of the collectable may be acquired, at a step of S209, from each of the first buyer 400-1 to the n-th buyer 400-n. Herein, n may be an integer greater than 0.

It is appreciated that a buyer is a person who wishes to buy the ownership tokens or a device of the buyer.

In addition, each of the first buyer 400-1 to the n-th buyer 400-n may randomly select each cardinal number of the ownership tokens to be bought within a buyable maximum limit set for an individual.

As an example, each of the first buyer 400-1 to the n-th buyer 400-n who acquired the ownership distribution participation request for the collectable registered for distribution by the online transaction server 100 may individually pay each of distributed prices to indicate its corresponding intention of participating in the ownership distribution, and herein, the acquired ownership distribution participation information from each of the first buyer 400-1 to the n-th buyer 400-n may be payment information of the first buyer 400-1 to the n-th buyer 400-n.

Herein, methods of payments available to the first buyer 400-1 to the n-th buyer 400-n for settling the distributed prices may be cash, credit card, online payment, reward points, virtual assets, and cryptocurrencies, but they are not limited thereto.

Moreover, the first buyer 400-1 to the n-th buyer 400-n may install their corresponding digital wallets for managing the ownership tokens, and may provide their corresponding digital wallets' addresses to the online transaction server 100.

Further, the online transaction server 100 may request each of a first administrator to an m-th administrator to sign at least one of the ownership token contract ID and ownership transferal information corresponding to the ownership distribution participation information, and acquire each of a first administrator signature value to a k-th administrator signature value, which is a signature value acquired by signing at least one of the ownership token contract ID and the ownership transferal information or at least one first hash value of at least one of the ownership token contract ID and the ownership transferal information with each of private keys from each of the first administrator to a k-th administrator. Herein, m is an integer greater than 0 and k is an integer greater than 0 and less than or equal to m.

Furthermore, the online transaction server 100 may generate an ownership transferal transaction which includes the ownership token contract ID, the ownership transferal information acquired by referring to the ownership distribution participation information, a second server signature value, which is a signature value of the online transaction server, and the first administrator signature value to the k-th administrator signature value, at a step of S210, and broadcast the ownership transferal transaction to the blockchain network 200, at a step of S211, to thereby instruct the blockchain nodes 200-1, 200-2, . . . , 200-n of the blockchain network 200 to verify the second server signature value and the first administrator signature value to the k-th administrator signature value, at steps of S212, S213.

It is appreciated that multi-signature values may be at least some of signature values of each of the first administrator to the m-th administrator, multi-signers may be at least some of the first administrator to the m-th administrator, but they are not limited thereto, and multi-signing may be equivalent to signing and are used interchangeably. Herein, multi-signing is performed by the multi-signers, but it is not limited thereto.

Moreover, upon verifying the second server signature value and the first administrator signature value to the k-th administrator signature value, the online transaction server 100, may instruct the blockchain nodes 200-1, 200-2, . . . , 200-n to (i) execute the ownership token contract corresponding to the ownership token contract ID, at a step of S214, to thereby check whether a ratio of (1) target multi-signers for comparison corresponding to the first administrator to the k-th administrator to (2) standard multi-signers corresponding to the first administrator to the m-th administrator satisfies a predetermined ratio, and (ii) if the predetermined ratio is satisfied, transfer ownership tokens corresponding to the collectable to the first buyer 400-1 to the n-th buyer 400-n who have participated in the ownership distribution according to the ownership transferal information.

It is to be understood that the standard multi-signers may be all of the participating multi-signers, such as administrators, but they are not limited thereto, and the target multi-signers for comparison may be a part of multi-signers that are needed to meet a target to perform a certain process, but they are not limited thereto.

Herein, after completing the ownership distribution of the collectable, the ownership tokens may be transferred to all participants.

For instance, assuming that each of three buyers sequentially pays 3 million won, 3 million won, and 4 million won, respectively, for an ownership of the collectable whose total distributed price is set as 10 million won, the ownership tokens will be transferred to the three buyers only after the third buyer, i.e., the last buyer, completes a payment of 4 million won.

That is, for a case when the ownership tokens get transferred upon a completion of distributing the ownership of the collectable, the online transaction server 100 may, (i) in response to acquiring the ownership distribution participation information which includes first buyer distribution participation information and n-th buyer distribution participation information from the first buyer 400-1 to the n-th buyer 400-n upon the completion of distributing the ownership of the collectable, (i) request each of the first administrator to the m-th administrator to sign at least one of the ownership token contract ID and the ownership transferal information, and (ii) acquire each of the first administrator signature value to the k-th administrator signature value from each of the first administrator to the k-th administrator. Herein, the ownership transferal information may include a first buyer's digital wallet address to an n-th buyer's digital wallet address and a first cardinal number of the ownership tokens to be transferred to an n-th cardinal number of the ownership tokens to be transferred.

Further, the online transaction server 100 may (i-1) broadcast, to the blockchain network 200, the ownership transferal transaction which includes the ownership token contract ID, the ownership transferal information, the second server signature value, and the first administrator signature value to the k-th administrator signature value, wherein the ownership transferal information includes the first buyer's digital wallet address to the n-th buyer's digital wallet address and the first cardinal number of the ownership tokens to be transferred to the n-th cardinal number of the ownership tokens to be transferred, and wherein the second server signature value is acquired by signing at least one of the ownership token contract ID and the ownership transferal information with a transaction server private key of the online transaction server 100, or (i-2) broadcast, to the blockchain network 200, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information.

Furthermore, the online transaction server 100 may instruct the blockchain nodes 200-1, 200-2, . . . , 200-n to (i-1) (i-1-1) (i-1-1-1) decrypt the second server signature value and the first administrator signature value to the k-th administrator signature value by using a transaction server public key of the online transaction server 100 and each of public keys of the first administrator to the k-th administrator, (i-1-1-2) acquire at least one of the ownership token contract ID and the ownership transferal information as a result of said (i-1-1-1), and (i-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (i-1-2) (i-1-2-1) decrypt the second server signature value and the first administrator signature value to the k-th administrator signature value by using the transaction server public key and each of the public keys of the first administrator to the k-th administrator, (i-1-2-2) acquire the first hash value as a result of said (i-1-2-1), (i-1-2-3) generate a second hash value by hashing at least one of the ownership token contract ID and the ownership transferal information, and (i-1-2-4) check whether the first hash value matches with the second hash value, to thereby verify the second server signature value and the first administrator signature value to the k-th administrator signature value.

Moreover, in response to verifying the second server signature value and the first administrator signature value to the k-th administrator signature value, the online transaction server 100 may instruct the blockchain nodes 200-1, 200-2, . . . , 200-n to (i) execute the ownership token contract, to thereby check whether the ratio of (1) the target multi-signers for comparison corresponding to the first administrator to the k-th administrator to (2) the standard multi-signers corresponding to the first administrator to the m-th administrator satisfies the predetermined ratio, and (ii) if the predetermined ratio is satisfied, transfer the first cardinal number of the ownership tokens to be transferred to the n-th cardinal number of the ownership tokens to be transferred respectively to the first buyer's digital wallet address to the n-th buyer's digital wallet address.

In addition, in response to acquiring transfer complete information indicating that the ownership tokens have been transferred to the first buyer 400-1 to the n-th buyer 400-n participating in the ownership distribution, the online transaction server 100 may send the transfer complete information to the first buyer 400-1 to the n-th 400-n buyer and send settled distributed price information to the owner 300.

Contrary to the above, the ownership tokens may be transferred to individual buyers whenever participation for the collection distribution is made individually.

For instance, assuming that each of three buyers sequentially pays 3 million won, 3 million won, and 4 million won, respectively, for the ownership of the collectable whose total distributed price is set as 10 million won, then when the first buyer completes a first amount of payment, the ownership tokens corresponding to the first amount may be transferred to the first buyer, when the second buyer completes a second amount of payment, the ownership tokens corresponding to the second amount may be transferred to the second buyer, and when the final and third buyer completes a third amount of payment, ownership tokens corresponding to the third amount may be transmitted to the third buyer.

That is, the online transaction server 100, in response to acquiring the ownership distribution participation information which includes specific buyer distribution participation information upon a partial completion of distributing the ownership of the collectable by a specific buyer 400-k among the first buyer 400-1 to the n-th buyer 400-n, may (i) request each of the first administrator to the m-th administrator to sign at least one of the ownership token contract ID and the ownership transferal information, and (ii) acquire the first administrator signature value to the k-th administrator signature value. Herein, the ownership transferal information includes a specific buyer's digital wallet address and a specific cardinal number of the ownership tokens to be transferred.

Further, the online transaction server 100 may (i-1) broadcast, to the blockchain network 200, the ownership transferal transaction which includes the ownership token contract ID, the ownership transferal information, the second server signature value and the first administrator signature value to the k-th administrator signature value, wherein the ownership transferal information includes the specific buyer's digital wallet address and the specific cardinal number of the ownership tokens to be transferred, and wherein the second server signature value is acquired by signing at least one of the ownership token contract ID and the ownership transferal information with the transaction server private key of the online transaction server 100, or (i-2) broadcast, to the blockchain network 200, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information.

Furthermore, the online transaction server 100 may instruct the blockchain nodes 200-1, 200-2, . . . , 200-n to (i-1) (i-1-1) (i-1-1-1) decrypt the second server signature value and the first administrator signature value to the k-th administrator signature value by using the transaction server public key of the online transaction server 100 and each of the public keys of the first administrator to the k-th administrator, (i-1-1-2) acquire at least one of the ownership token contract ID and the ownership transferal information as a result of said (i-1-1-1), and (i-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (i-1-2) (i-1-2-1) decrypt the second server signature value and the first administrator signature value to the k-th administrator signature value by using the transaction server public key and each of the public keys of the first administrator to the k-th administrator, (i-1-2-2) acquire the first hash value as a result of said (i-1-2-1), (i-1-2-3) generate the second hash value by hashing at least one of the ownership token contract ID and the ownership transferal information, and (i-1-2-4) check whether the first hash value matches with the second hash value, to thereby verify the second server signature value and the first administrator signature value to the k-th administrator signature value.

Moreover, in response to verifying the second server signature value and the first administrator signature value to the k-th administrator signature value, the online transaction server 100 may instruct the blockchain nodes 200-1, 200-2, . . . , 200-n to (i) execute the ownership token contract, to thereby check whether the ratio of (1) the target multi-signers for comparison corresponding to the first administrator to the k-th administrator to (2) the standard multi-signers corresponding to the first administrator to the m-th administrator satisfies the predetermined ratio, and (ii) if the predetermined ratio is satisfied, transfer the specific cardinal number of the ownership tokens to be transferred to the specific digital wallet address.

The above process may be repeated until the ownership distribution of the collectable is finished.

In addition, in response to acquiring the transfer complete information indicating that the ownership tokens have been transferred to the specific buyer 400-k participating in the ownership distribution, the online transaction server 100 may send the transfer complete information to the specific buyer 400-k, repeat the above process for other specific buyers until the ownership distribution of the collectable is finished, and send settled distributed price information to the owner 300.

It is appreciated that any one of the buyers who received the ownership tokens may hand over his or her ownership tokens to a new buyer 500.

That is, the online transaction server 100 may (i) allow the ownership tokens to be transferred to the first buyer 400-1 to the n-th 400-n buyer through the blockchain network 200, (ii) allow the specific buyer among the first 400-1 to the n-th 400-n buyer who received an ownership token transferal request from the new buyer 500, at a step of S301, to (ii-1) generate an ownership token transferal transaction which includes the ownership token contract ID, a new buyer's digital wallet address, a new cardinal number of the ownership tokens to be transferred, and a specific buyer signature value which is acquired by signing (ii-1-1) at least one of the ownership token contract ID, the new buyer's digital wallet address, and the new cardinal number of the ownership tokens to be transferred with a specific buyer private key of the specific buyer, or (ii-1-2) at least one third hash value of at least one of the ownership token contract ID, the new buyer's digital wallet address, and the new cardinal number of ownership tokens to be transferred with the specific buyer private key of the specific buyer, at a step of S302,

Further, the online transaction server 100 may allow the specific buyer 400-k to request the online transaction server 100 to multi-sign, at a step of S303, to allow the first administrator to the k-th administrator to multi-sign (i-2-1) at least one of the ownership token contract ID, the new buyer's digital wallet address, and the new cardinal number of the ownership tokens to be transferred with each of the private keys from each of the first administrator to the k-th administrator, or (i-2-2) the at least one third hash value of at least one of the ownership token contract ID, the new buyer's digital wallet address, and the new cardinal number of ownership tokens to be transferred with each of the private keys from each of the first administrator to the k-th administrator, to thereby acquire multi-signature values which include a first administrator transferal signature value to a k-th administrator transferal signature value from the first administrator to the k-th administrator, at a step of S305, and thus broadcast the ownership token transferal request, which includes the ownership token transferal transaction and the multi-signature values, to the blockchain network 200, at a step of S306.

Furthermore, the online transaction server 100 may instruct the blockchain nodes 200-1, 200-2, . . . , 200-n to (i-1) (i-1-1) (i-1-1-1) decrypt the specific buyer signature value and the first administrator transferal signature value to the k-th administrator transferal signature value by using a specific buyer public key of the specific buyer 400-k and each of the public keys of the first administrator to the k-th administrator, (i-1-1-2) acquire at least one of the ownership token contract ID, the new buyer's digital wallet address and the new cardinal number of the ownership tokens to be transferred as a result of said (i-1-1-1), and (i-1-1-3) check whether the acquired at least one of the ownership token contract ID, the new buyer's digital wallet address, and the new cardinal number of the ownership tokens to be transferred matches with the at least one of the ownership token contract ID, the new buyer's digital wallet address, and the new cardinal number of the ownership tokens to be transferred included in the ownership token transferal request, to thereby verify the specific buyer signature value and the first administrator transferal signature value to the k-th administrator transferal signature value, at steps of S307 and S308, or (i-1-2) (i-1-2-1) decrypt the specific buyer signature value and the first administrator transferal signature value to the k-th administrator transferal signature value by using the specific buyer public key of the specific buyer and each of the public keys of the first administrator to the k-th administrator, (i-1-2-2) acquire the third hash value as a result of said (i-1-2-1), (i-1-2-3) generate a fourth hash value by hashing at least one of the ownership token contract ID, the new buyer's digital wallet address, and the new cardinal number of the ownership tokens to be transferred, and (i-1-2-4) check whether the third hash value matches with the fourth hash value, to thereby verify the specific buyer signature value and the first administrator transferal signature value to the k-th administrator transferal signature value, at the steps of S307 and S308.

Moreover, in response to verifying the specific buyer signature value and the first administrator transferal signature value to the k-th administrator transferal signature value, the online transaction server 100 may instruct the blockchain nodes 200-1, 200-2, . . . , 200-n to (i) execute the ownership token contract, at a step of S309, to thereby check whether the ratio of (1) the target multi-signers for comparison corresponding to the first administrator to the k-th administrator to (2) the standard multi-signers corresponding to the first administrator to the m-th administrator satisfies the predetermined ratio, and (ii) if the predetermined ratio is satisfied, transfer the new cardinal number of the ownership tokens to be transferred to the new buyer's digital wallet address.

In addition, the online transaction server 100 may instruct the blockchain nodes 200-1, 200-2, . . . , 200-n to transfer the ownership tokens to the new buyer's digital wallet address and send transfer complete information from the specific buyer 400-k to the new buyer 500, to thereby allow the new buyer 500 to check information on the ownership tokens owned by the new buyer 500 from the blockchain network 200 by using the transfer complete information.

Specifically, the online server 100, in response to a request from the new buyer 500 for ownership token balance checking of the new buyer's digital wallet address being broadcasted to the blockchain network 200, may instruct the blockchain nodes 200-1, 200-2, 200-n to execute the ownership token contract, to thereby generate ownership token balance information corresponding to the request for ownership token balance checking and send the ownership token balance information to the new buyer 500.

It is appreciated that termination procedures for the ownership tokens and sale price settlement procedures for the first buyer 400-1 to the n-th buyer 400-n may occur when a sale of the collectable per se takes place, given that each of the first buyer 400-1 to the n-th buyer 400-n holds each of his or hers own ownership tokens.

That is, the online transaction server 100, in response to acquiring sale completion information, may send an ownership token holder lookup request, which includes the ownership token contract ID, to the blockchain network 200, and instruct the blockchain nodes 200-1, 200-2, . . . , 200-n to execute the ownership token contract, to thereby generate ownership token holder lookup information corresponding to the ownership token holder lookup request, and send the ownership token holder lookup information to the online transaction server 100.

In addition, the online transaction server 100 may (i) send an ownership token collection request to the first buyer 400-1 to the n-th buyer 400-n for liquidating the ownership tokens corresponding to the collectable by referring to the ownership token holder lookup information, at a step of S401, (ii) allow the first buyer 400-1 to the n-th buyer 400-n to (ii-1) generate each of a first ownership token return transaction to an n-th ownership token return transaction which includes the ownership token contract ID, a transaction server's digital wallet address corresponding to the online transaction server 100, a first cardinal number of the ownership tokens to be returned to an n-th cardinal number of the ownership tokens to be returned, and each of a first buyer signature value to an n-th buyer signature value which is acquired by signing at least one of the ownership token contract ID, the transaction server's digital wallet address, the first cardinal number of the ownership tokens to be returned to the n-th cardinal number of the ownership tokens to be returned with each of a first buyer private key to an n-th buyer private key corresponding to each of the first buyer 400-1 to the n-th buyer 400-n, at a step of S402, to thereby broadcast the first ownership token return transaction to the n-th ownership token return transaction to the blockchain network 200, at a step of S403, or (ii-2) generate each of the first ownership token return transaction to the n-th ownership token return transaction which includes the ownership token contract ID, the transaction server's digital wallet address corresponding to the online transaction server 100, the first cardinal number of the ownership tokens to be returned to the n-th cardinal number of the ownership tokens to be returned, and each of the first buyer signature value to the n-th buyer signature value which is acquired by signing a fifth hash value with each of the first buyer private key to the n-th buyer private key, wherein the fifth hash value is acquired by hashing at least one of the ownership token contract ID, the transaction server's digital wallet address, and the first cardinal number of the ownership tokens to be returned to the n-th cardinal number of the ownership tokens to be returned, at the step of S402, to thereby broadcast the first ownership token return transaction to the n-th ownership token return transaction to the blockchain network 200, at the step of S403.

As an example, the online transaction server 100 may allow the first buyer 400-1 to (i) generate the first ownership token return transaction which includes the ownership token contract ID, the transaction server's digital wallet address corresponding to the online transaction server 100, the first cardinal number of the ownership tokens to be returned, and the first buyer signature which is acquired by signing at least one of the ownership token contract ID, the transaction server's digital wallet address, the first cardinal number of the ownership tokens to be returned with the first buyer private key corresponding to the first buyer 400-1, to thereby broadcast the first ownership token return transaction to the blockchain network 200, or (ii-2) generate the first ownership token return transaction which includes the ownership token contract ID, the transaction server's digital wallet address corresponding to the online transaction server 100, the first cardinal number of the ownership tokens to be returned, and the first buyer signature value which is acquired by signing the fifth hash value with the first buyer private key, wherein the fifth hash value is acquired by hashing at least one of the ownership token contract ID, the transaction server's digital wallet address, and the first cardinal number of the ownership tokens to be returned, to thereby broadcast the first ownership token return transaction to the blockchain network 200. It is to be understood that the above description of the first buyer 400-1 is provided to aid with understanding and the description thereof is applicable to the other buyers.

In addition, the online transaction server 100 may instruct the blockchain nodes 200-1, 200-2, . . . , 200-n to (i-1) (i-1-1) decrypt the first buyer signature value to the n-th buyer signature value by using the first buyer public key to the n-th buyer public key corresponding to the first buyer 400-1 to the n-th buyer 400-n, (i-1-2) acquire at least one of the ownership token contract ID, the transaction server's digital wallet address, and the first cardinal number of the ownership tokens to be returned to the n-th cardinal number of the ownership tokens to be returned as a result of said (i-1-1), and (i-1-3) check whether the acquired at least one of the ownership token contract ID, the transaction server's digital wallet address, and the first cardinal number of the ownership tokens to be returned to the n-th cardinal number of the ownership tokens to be returned matches with at least one of the ownership token contract ID, the transaction server's digital wallet address, and the first cardinal number of the ownership tokens to be returned to the n-th cardinal number of the ownership tokens to be returned included in the first ownership token return transaction to the n-th ownership token return transaction, to thereby verify the first buyer signature value to the n-th buyer signature value, at a step of S404, or (i-2) (i-2-1) decrypt the first buyer signature value to the n-th buyer signature value by using the first buyer public key to the n-th buyer public key, (i-2-2) acquire the fifth hash value as a result of said (i-2-1), (i-2-3) generate an sixth hash value by hashing at least one of the ownership token contract ID, the transaction server's digital wallet address, and the first cardinal number of the ownership tokens to be returned to the n-th cardinal number of the ownership tokens to be returned, and (i-2-4) check whether the fifth hash value matches with the sixth hash value, to thereby verify the first buyer signature value to the n-th buyer signature value, at the step of S404.

As an example, the online transaction server 100 may instruct the blockchain nodes 200-1, 200-2, . . . , 200-n to (i-1) (i-1-1) decrypt the first buyer signature value by using the first buyer public key corresponding to the first buyer 400-1, (i-1-2) acquire at least one of the ownership token contract ID, the transaction server's digital wallet address, and the first cardinal number of the ownership tokens to be returned as a result of said (i-1-1), and (i-1-3) check whether the acquired at least one of the ownership token contract ID, the transaction server's digital wallet address, and the first cardinal number of the ownership tokens to be returned matches with at least one of the ownership token contract ID, the transaction server's digital wallet address, and the first cardinal number of the ownership tokens to be returned included in the first ownership token return transaction, to thereby verify the first buyer signature value, or (i-2) (i-2-1) decrypt the first buyer signature value by using the first buyer public key, (i-2-2) acquire the fifth hash value as a result of said (i-2-1), (i-2-3) generate the sixth hash value by hashing at least one of the ownership token contract ID, the transaction server's digital wallet address, and the first cardinal number of the ownership tokens to be returned, and (i-2-4) check whether the fifth hash value matches with the sixth hash value, to thereby verify the first buyer signature value to the n-th buyer signature value. It is to be understood that the above description of the first buyer 400-1 is provided to aid with understanding and the description thereof is applicable to the other buyers.

Furthermore, the online transaction server 100, in response to verifying the first buyer signature value to the n-th buyer signature value, may instruct the blockchain nodes 200-1, 200-2, . . . , 200-n to execute the ownership token contract, at a step of S405, to thereby transfer the first cardinal number of the ownership tokens to be transferred to the n-th cardinal number of the ownership tokens to be transferred to the transaction server's digital wallet address.

Additionally, upon a complete termination of the total ownership tokens corresponding to all buyers, the online transaction sever 100 may settle a sale price to each individual buyer, or may settle the sale price whenever each of ownership tokens corresponding to each of the individual buyers is terminated.

Firstly, a case of settling the sale price after the total ownership tokens are terminated will be explained. The online transaction server 100, in response to collecting the ownership tokens from the first buyer 400-1 to the nth buyer 400-n, may (i) request each of the first administrator to the m-th administrator to sign at least one of the ownership token contract ID and the transaction server's digital wallet address, and (ii) acquire a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one seventh hash value of at least one of the ownership token contract ID and the transaction server's digital wallet address with each of the private keys of the first administrator to the k-th administrator.

Further, the online transaction server 100 may (i-1) generate an ownership token termination transaction which includes the ownership token contract ID, the transaction server's digital wallet address, a third server signature value, and the first administrator termination signature value to the k-th administrator termination signature value, wherein the third server signature value is acquired by signing at least one of the ownership token contract ID and the transaction server's digital wallet address with the transaction server private key of the online transaction server 100, at a step of S501, to thereby broadcast the ownership token termination transaction to the blockchain network 200, at a step of S502, or (i-2) generate the ownership token termination transaction which includes the ownership token contract ID, the transaction server's digital wallet address, the third server signature value and the first administrator termination signature value to the k-th administrator termination signature value, wherein the third server signature value is acquired by signing the seventh hash value with the transaction server private key, and wherein the seventh hash value is acquired by hashing at least one of the ownership token contract ID and the transaction server's digital wallet address, at the step S501 to thereby broadcast the ownership token termination transaction to the blockchain network, at the step of S502.

Furthermore, the online transaction server 100 may instruct the blockchain nodes 200-1, 200-2, . . . , 200-n to (i-1) (i-1-1) (i-1-1-1) decrypt the third server signature value and the first administrator termination signature value to the k-th administrator termination signature value by using the transaction server public key of the online transaction server 100 and each of public keys of the first administrator to the k-th administrator, (i-1-1-2) acquire at least one of the ownership token contract ID and the transaction server's digital wallet address as a result of said (i-1-1-1), and (i-1-1-3) check whether the acquired at least one of the ownership token contract ID and the transaction server's digital wallet address matches with at least one of the ownership token contract ID and the transaction server's digital wallet address included in the ownership token termination transaction, to thereby verify the third server signature value and the first administrator termination signature value to the k-th administrator termination signature value, at steps of S503 and S504, or (i-1-2) (i-1-2-1) decrypt the third server signature value and the first administrator termination signature value to the k-th administrator termination signature value by using the transaction server public key and each of the public keys of the first administrator to the k-th administrator, (i-2-2) acquire the seventh hash value as a result of said (i-1-2-1), (i-1-2-3) generate an eighth hash value by hashing at least one of the ownership token contract ID and the transaction server's digital wallet address, and (i-1-2-4) check whether the seventh hash value matches with the eighth hash value, to thereby verify the third server signature value and the first administrator termination signature value to the k-th administrator termination signature value, at the steps of S503 and S504.

Herein, a cardinal number of ownership tokens to be terminated may be additionally included in the token termination transaction, and the third server signature value may be (i) acquired by signing at least one of the ownership token contract ID, the transaction server's digital wallet address, and the cardinal number of ownership tokens to be terminated with the transaction server private key, or (ii) acquired by signing the seventh hash value with the transaction server private key, wherein the seventh hash value is acquired by hashing at least one of the ownership token contract ID, the transaction server's digital wallet address, and the cardinal number of ownership tokens to be terminated.

Moreover, in response to verifying the third server signature value and the first administrator termination signature value to the k-th administrator termination signature value, the online transaction server 100 may instruct the blockchain nodes 200-1, 200-2, . . . , 200-n to (i) execute the ownership token contract, at a step of S505, to thereby check whether the ratio of (1) the target multi-signers for comparison corresponding to the first administrator to the k-th administrator to (2) the standard multi-signers corresponding to the first administrator to the m-th administrator satisfies the predetermined ratio, and (ii) if the predetermined ratio is satisfied, terminate the ownership tokens having been transferred from the first buyer to the n-th buyer. As such, when all ownership tokens are terminated, the online transaction server 100 may send settled sale price information to each of the first buyer 400-1 to the n-th buyer 400-n.

Next, a case of settling the sale price whenever each of ownership tokens corresponding to each of the individual buyers is terminated will be explained. The online transaction server 100, in response to collecting specific ownership tokens from the specific buyer 400-k among the first buyer 400-1 to the nth buyer 400-n, may (i) request each of the first administrator to the m-th administrator to sign at least one of the ownership token contract ID and the transaction server's digital wallet address, and (ii) acquire the first administrator termination signature value to the k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one ninth hash value of at least one of the ownership token contract ID and the transaction server's digital wallet address with each of the private keys of the first administrator to the k-th administrator.

Further, the online transaction server 100 may (i-1) generate the ownership token termination transaction which includes the ownership token contract ID, the transaction server's digital wallet address, a fourth server signature value, and the first administrator termination signature value to the k-th administrator termination signature value, wherein the fourth server signature value is acquired by signing at least one of the ownership token contract ID and the transaction server's digital wallet address with the transaction server private key of the online transaction server 100, to thereby broadcast the ownership token termination transaction to the blockchain network 200, or (i-2) generate the ownership token termination transaction which includes the ownership token contract ID, the transaction server's digital wallet address, the fourth server signature value and the first administrator termination signature value to the k-th administrator termination signature value, wherein the fourth server signature value is acquired by signing the ninth hash value with the transaction server private key, and wherein the ninth hash value is acquired by hashing at least one of the ownership token contract ID and the transaction server's digital wallet address, to thereby broadcast the ownership token termination transaction to the blockchain network 200.

Furthermore, the online transaction server 100 may instruct the blockchain nodes 200-1, 200-2, . . . , 200-n to (i-1) (i-1-1) (i-1-1-1) decrypt the fourth server signature value and the first administrator termination signature value to the k-th administrator termination signature value by using the transaction server public key of the online transaction server 100 and each of the public keys of the first administrator to the k-th administrator, (i-1-1-2) acquire at least one of the ownership token contract ID and the transaction server's digital wallet address as a result of said (i-1-1-1), and (i-1-1-3) check whether the acquired at least one of the ownership token contract ID and the transaction server's digital wallet address matches with at least one of the ownership token contract ID and the transaction server's digital wallet address included in the ownership token termination transaction, to thereby verify the fourth server signature value and the first administrator termination signature value to the k-th administrator termination signature value, or (i-1-2) (i-1-2-1) decrypt the fourth server signature value and the first administrator termination signature value to the k-th administrator termination signature value by using the transaction server public key and each of the public keys of the first administrator to the k-th administrator, (i-1-2-2) acquire the ninth hash value as a result of said (i-1-2-1), (i-1-2-3) generate a tenth hash value by hashing at least one of the ownership token contract ID and the transaction server's digital wallet address, and (i-1-2-4) check whether the ninth hash value matches with the tenth hash value, to thereby verify the fourth server signature value and the first administrator termination signature value to the k-th administrator termination signature value.

Herein, the cardinal number of ownership tokens to be terminated may be additionally included in the token termination transaction, and the fourth server signature value may be (i) acquired by signing at least one of the ownership token contract ID, the transaction server's digital wallet address, and the cardinal number of ownership tokens to be terminated with the transaction server private key, or (ii) acquired by signing the ninth hash value with the transaction server private key, wherein the ninth hash value is acquired by hashing at least one of the ownership token contract ID, the transaction server's digital wallet address, and the cardinal number of ownership tokens to be terminated.

Moreover, in response to verifying the fourth server signature value and the first administrator termination signature value to the k-th administrator termination signature value, the online transaction server 100 may instruct the blockchain nodes 200-1, 200-2, . . . , 200-n to (i) execute the ownership token contract, to thereby check whether the ratio of (1) the target multi-signers for comparison corresponding to the first administrator to the k-th administrator to (2) the standard multi-signers corresponding to the first administrator to the m-th administrator satisfies the predetermined ratio, and (ii) if the predetermined ratio is satisfied, terminate the specific ownership tokens having been transferred from the specific buyer among first buyer to the n-th buyer. As such, whenever the specific ownership tokens corresponding to the specific buyer 400-k are terminated, the online transaction server 100 may send the sale price settlement information to the specific buyer 400-k.

It is appreciated that when the sale of the collectable per se takes place, a payment transaction between the purchaser willing to purchase the collectable per se and the online transaction server 100 may be made via account transfer, credit card, and third-party payment, etc., and the online transaction server 100 may settle the sale price for the first buyer 400-1 to the n-th buyer 400-n by performing the sale price settlement procedures, but it is not limited thereto.

For example, if the purchaser willing to purchase the collectable per se is trying to make payment via cryptocurrencies, the cryptocurrencies will not get transferred to the first buyer 400-1 to the n-th buyer 400-n through the online transaction server 100, but instead get transferred to an escrow wallet on the blockchain network 200, where a smart contract can be executed to transfer the cryptocurrencies stored in the escrow wallet to the first buyer 400-1 to the n-th buyer 400-n.

It is appreciated that when the sale of the collectable per se takes place, the ownership tokens each held by the first buyer 400-1 to the n-th buyer 400-n may be returned to the online transaction server 100 to thereby allow the sale price to be settled by performing the ownership token termination procedures, but it is not limited thereto.

For example, if the sale of the collectable per se takes place, the ownership tokens held by each of the first buyer 400-1 to the n-th buyer 400-n may not be returned to the online transaction server 100, but the ownership tokens held by themselves may be terminated by themselves, to thereby allow the sale price to be settled by the online transaction server 100.

Various cases of the first buyer 400-1 to the n-th buyer 400-n directly managing their own digital wallet has been described in the above description.

However, a situation where a private key is lost due to a mistake, etc. of a token owner may occur when the token owner directly manage its own digital wallet.

Therefore, in order to prevent the above situation, a third party is introduced to manage token owners' digital wallets on behalf of token owners, but manage by utilizing multi-signatures, to thereby increase a service reliability.

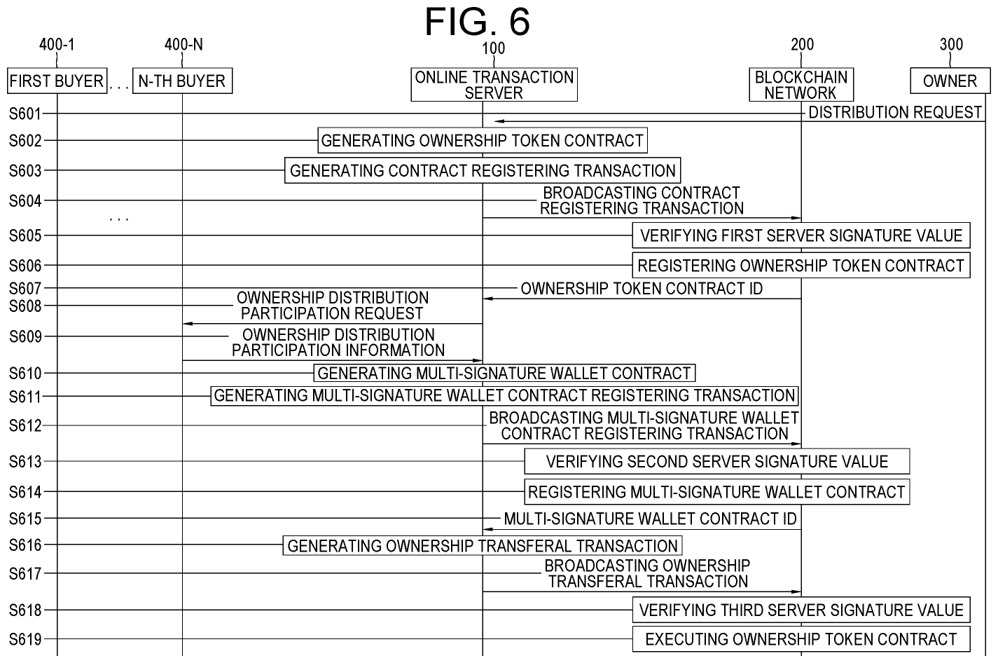

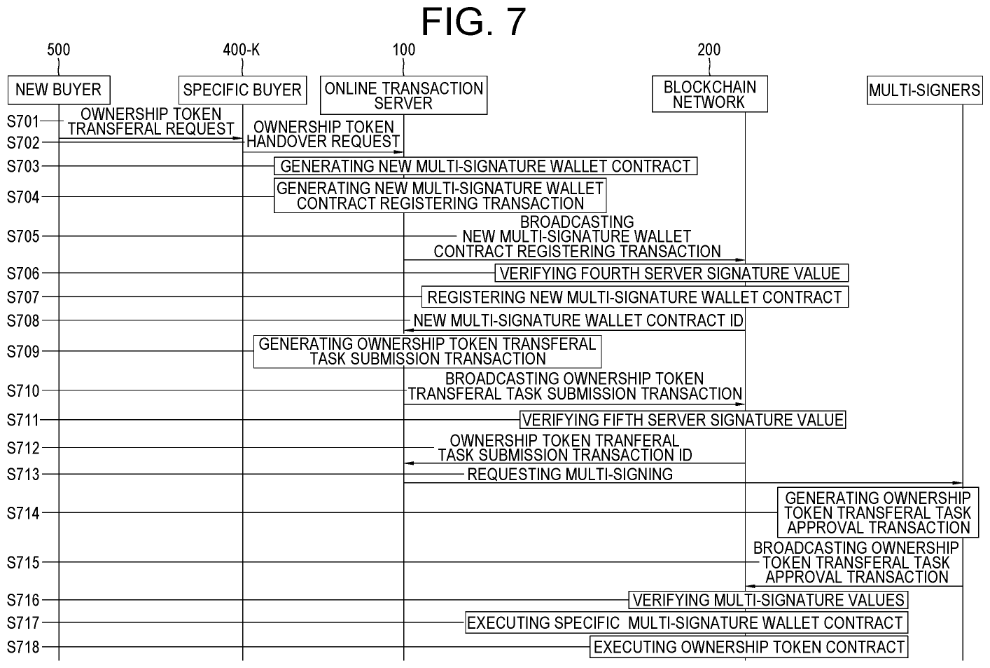

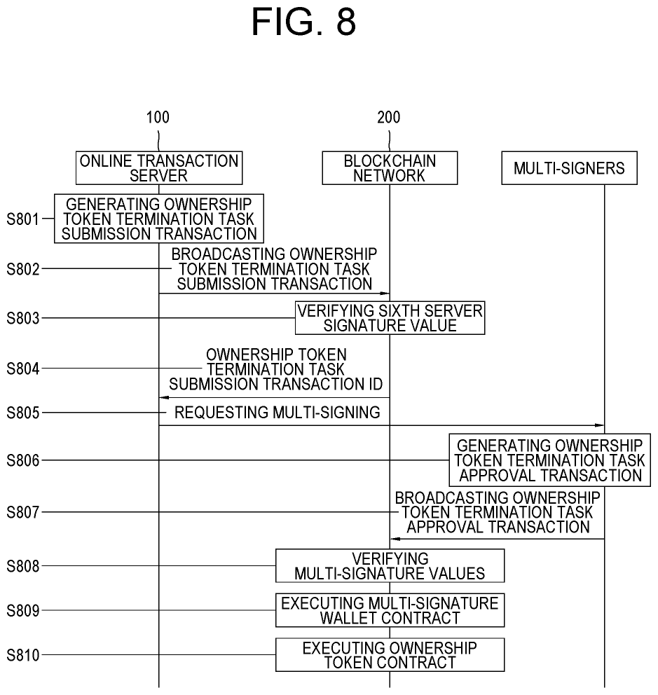

Processes for distributing the collectable ownership by the online transaction server 100 and the blockchain network 200 where multi-signers manage digital wallets of the first buyer 400-1 to n-th buyer 400-n will be described below with reference to FIGS. 6 to 8.

First, in response to acquiring the distribution request for the collectable from the owner 300 who owns the collectable, at a step of S601, the online transaction server 100 may generate an ownership token contract for distributing the collectable ownership at a step of S602. Herein, the owner 300 represents a person who owns the collectable or the owner device corresponding to the person who owns the collectable.

Herein, the owner 300 may send the collectable to the service provider who provides the service of online transaction to allow the service provider to inspect the collectable, and when the inspection is completed, the service provider may generate the ownership token contract corresponding to the collectable.

Herein, the ownership token contract may include the information on an ownership token structure and the information on an ownership token function corresponding to the collectable.

Specifically, the ownership token structure may include the information on the collectable, the information on the ownership token ID, and the cardinal number of issued ownership tokens.

Herein, the information on the collectable may be the ownership token name, and may include the information on the content related to the collectable ownership token. More specifically, the information on the collectable may include at least part of the information on the collectable ownership distribution ID, the item type of the collectable, the name of the collectable, the maker of the collectable, the brand of the collectable, the date of creation of the collectable, the size of the collectable, the color of the collectable, the material of the collectable, and the inspection result of the collectable, but it is not limited thereto.

In addition, the total number of issuable tokens, or the maximum number of buyable tokens per person may be determined according to one or more conditions such as the type of the collectable.

Moreover, the ownership token function may include at least part of the ownership token transferal function, the ownership token termination function, the ownership token balance checking function, the ownership token transfer history tracking function, the ownership token restriction function, the ownership token lookup function, and the ownership token holder lookup function, but it is not limited thereto.

In addition, the online transaction server 100 may (i) generate the contract registering transaction which includes the ownership token contract and the first server signature value, which is a signature value of the online transaction server 100, at a step of S603, and (ii) broadcast the contract registering transaction to the blockchain network 200, at a step of S604, to thereby instruct the blockchain nodes 200-1, 200-2, . . . , 200-n of the blockchain network 200 to (ii-1) verify the first server signature value, at a step of S605 (ii-2) in response to verifying the first server signature value, register the ownership token contract, included in the contract registering transaction, in the blockchain network 200, at a step of S606, and (ii-3) transfer the ownership token contract ID corresponding to the ownership token contract registered in the blockchain network 200 to the online transaction server 100, at a step of S607.

Herein, the transaction server public key of the online transaction server 100 should be registered in the blockchain network 200 in order to allow the signature values of the online transaction sever 100, e.g., the first server signature value, to be verified by the blockchain nodes 200-1, 200-2, . . . , 200-n.

Further, the online transaction server 100 may allow the transaction server public key to be included in each of the transactions generated by the online transaction server 100, to thereby instruct the blockchain nodes 200-1, 200-2, . . . , 200-n to acquire the transaction server public key from the transactions.

Furthermore, the online transaction server 100 may generate the first server signature value by electronically signing the ownership token contract with the transaction server private key of the online transaction server 100, but it is not limited thereto. For instance, the contract registering transaction may further include the nonce generated by the online transaction server 100, and the online transaction server 100 may generate the first server signature value by electronically signing the nonce by using the transaction server private key of the online transaction server 100.

Additionally, the ownership token contract ID may include the ownership token contract address. Hereinafter each of contract IDs of each of contracts may include each of contract addresses, and therefore repetitive descriptions thereon will be omitted.

For reference, other signature values of the online transaction server 100 and signature values of the first buyer 400-1 to the n-th buyer 400-n may also be generated by performing similar processes as described above, and therefore detailed descriptions thereon will be omitted.

Further, according to the ownership distribution participation request for the collectable at a step of S608, each piece of the ownership distribution participation information for participating in an ownership distribution of the collectable may be acquired, at a step of S609, from each of the first buyer 400-1 to the n-th buyer 400-n. Herein, n may be an integer greater than 0.

It is appreciated that the buyer is a person who wishes to buy the ownership tokens or the device of the buyer.

In addition, each of the first buyer 400-1 to the n-th buyer 400-n may randomly select each cardinal number of the ownership tokens to be bought within the buyable maximum limit set for the individual.

As an example, each of the first buyer 400-1 to the n-th buyer 400-n who acquired the ownership distribution participation request for the collectable registered for distribution by the online transaction server 100 may individually pay each of the distributed prices to indicate its corresponding intention of participating in the ownership distribution, and herein, the acquired ownership distribution participation information from each of the first buyer 400-1 to the n-th buyer 400-n may be the payment information of the first buyer 400-1 to the n-th buyer 400-n.

Herein, the methods of payments available to the first buyer 400-1 to the n-th buyer 400-n for settling the distributed prices may be cash, credit card, online payment, reward points, virtual assets, and cryptocurrencies, but they are not limited thereto.

Further, the online transaction server 100 may generate a first multi-signature wallet contract to an n-th multi-signature wallet contract, at a step of S610, in order to distribute the ownership tokens to each of the first buyer 400-1 to the n-th buyer 400-n.

Herein, each of the first multi-signature wallet contract to the n-th multi-signature wallet contract may include information on a multi-signature structure and a multi-signature function. Specifically, the multi-signature structure may include information on at least part of a cardinal number of people taking part in multi-signature, a minimum number of multi-signatures required to validate a multi-signature, and addresses of multi-signers; and the multi-signature function may include at least part of an ownership token related task submission function, an ownership token related task approval function, an ownership token related task executing function, a multi-signer adding function, a multi-signer deleting function, and a number changing function for changing the minimum number of multi-signatures.

It is appreciated that a multi-signer may be a specific node among nodes constituting the blockchain network 200 specifically configured to enable multi-signing.

Furthermore, the online transaction server 100 may generate at least one multi-signature wallet contract registering transaction, at a step of S611, which includes each of the first multi-signature wallet contract to the n-th multi-signature wallet contract and the second server signature value, which is a signature value of the online transaction server 100, and broadcast a multi-signature wallet contract registering transaction to the blockchain network 200, at a step of S612, to thereby instruct the blockchain nodes 200-1, 200-2, . . . , 200-n to verify the second server signature value, at a step of S613.

Moreover, in response to verifying the second server signature value, the online transaction server 100 may instruct the blockchain nodes 200-1, 200-2, . . . , 200-n to (i) register the first multi-signature wallet contract to the n-th multi-signature wallet contract included in the multi-signature wallet contract registering transaction in the blockchain network 200, at a step of S614, and (ii) transfer a first multi-signature wallet contract ID to an n-th multi-signature wallet contract ID corresponding to the first multi-signature wallet contract to the n-th multi-signature wallet contract registered in the blockchain network 200 to the online transaction server 100, at a step of S615.

In addition, the online transaction server 100 may (i) save each of the first multi-signature wallet contract ID to an n-th multi-signature wallet contract ID after matching them with each of the first buyer 400-1 to the n-th buyer 400-n, (ii) generate the ownership transferal transaction which includes the ownership token contract ID, the ownership transferal information acquired by referring to the ownership distribution participation information, and the third server signature value which is a signature value acquired by signing (i-1) at least one of the ownership token contract ID and the ownership transferal information with the transaction server private key of the online transaction server 100, or (i-2) at least one of the first hash value of at least one of the ownership token contract ID and the ownership transferal information, at a step of S616, and (iii) broadcast the ownership transferal transaction to the blockchain network 200, at a step of S617, to thereby instruct the blockchain nodes 200-1, 200-2, . . . , 200-n to verify the third server signature value, at a step of S618.

Further, in response to verifying the third server signature value, the online transaction server 100 may execute the ownership token contract corresponding to the ownership token contract ID, at a step of S619, and thus transfer each of the ownership tokens corresponding to the collectable to each of the first multi-signature wallet contract to the n-th multi-signature wallet contract corresponding to each of the first buyer 400-1 to the n-th buyer 400-n who have participated in the ownership distribution according to the ownership transferal information.

Herein, after completing the ownership distribution of the collectable, the ownership tokens may be transferred to all of the participants.

For instance, assuming that each of three buyers sequentially pays 3 million won, 3 million won, and 4 million won, respectively, for an ownership of the collectable whose total distributed price is set as 10 million won, the ownership tokens will be transferred to the three buyers only after the third buyer, i.e., the last buyer, completes a payment of 4 million won.

That is, for the case when the ownership tokens get transferred upon the completion of distributing the ownership of the collectable, the online transaction server 100 may, (i) in response to acquiring the ownership distribution participation information which includes first buyer distribution participation information and n-th buyer distribution participation information from the first buyer 400-1 to the n-th buyer 400-n upon the completion of distributing the ownership of the collectable, broadcast, to the blockchain network 200, the ownership transferal transaction which includes the ownership token contract ID, the ownership transferal information, and the third server signature value, wherein the third server signature value is acquired by signing at least one of the ownership token contract ID and the ownership transferal information with the transaction server private key of the online transaction server 100, or (i-2) broadcast, to the blockchain network 200, the ownership transferal transaction which includes the ownership token contract ID, the ownership transferal information, and the third server signature value which is acquired by signing the first hash value with the transaction server private key, wherein the first hash value is acquired by hashing at least one of the ownership token contract ID and the ownership transferal information.

Herein, the ownership transferal information may include a first multi-signature wallet contract's address to an n-th multi-signature wallet contract's address and the first cardinal number of the ownership tokens to be transferred to the n-th cardinal number of the ownership tokens to be transferred.

Further, the online transaction server 100 may instruct the blockchain nodes 200-1, 200-2, . . . , 200-n to (i-1) (i-1-1) (i-1-1-1) decrypt the third server signature value by using the transaction server public key of the online transaction server 100, (i-1-1-2) acquire at least one of the ownership token contract ID and the ownership transferal information as a result of said (i-1-1-1), and (i-1-1-3) check whether the acquired at least one of the ownership token contract ID and the ownership transferal information matches with at least one of the ownership token contract ID and the ownership transferal information included in the ownership transferal transaction, to thereby verify the third server signature value, or (i-1-2) (i-1-2-1) decrypt the third server signature value by using the transaction server public key, (i-1-2-2) acquire the first hash value as a result of said (i-1-2-1), (i-1-2-3) generate the second hash value by hashing at least one of the ownership token contract ID and the ownership transferal information, and (i-1-2-4) check whether the first hash value matches with the second hash value, to thereby verify the third server signature value.

Furthermore, in response to verifying the third serve signature value, the online transaction server 100 may instruct the blockchain nodes 200-1, 200-2, . . . , 200-n to execute the ownership token contract, to thereby transfer the first cardinal number of the ownership tokens to be transferred to the n-th cardinal number of the ownership tokens to be transferred respectively to the first multi-signature wallet contract's address to the n-th multi-signature wallet contract's address.

Moreover, in response to acquiring the transfer complete information indicating that the ownership tokens have been transferred to the first multi-signature wallet contract's address to the n-th multi-signature wallet contract's address corresponding to the first buyer 400-1 to the n-th buyer 400-n participating in the ownership distribution, the online transaction server 100 may send the transfer complete information to the first buyer 400-1 to the n-th 400-n buyer and send the settled distributed price information to the owner 300.

Contrary to the above, the ownership tokens may be transferred to the individual buyers whenever participation for the collection distribution is made individually.

For instance, assuming that each of three buyers sequentially pays 3 million won, 3 million won, and 4 million won, respectively, for the ownership of the collectable whose total distributed price is set as 10 million won, then when the first buyer completes the first amount of payment, the ownership tokens corresponding to the first amount may be transferred to the first buyer, when the second buyer completes the second amount of payment, the ownership tokens corresponding to the second amount may be transferred to the second buyer, and when the final and third buyer completes the third amount of payment, ownership tokens corresponding to the third amount may be transmitted to the third buyer.

That is, the online transaction server 100, in response to acquiring the ownership distribution participation information which includes the k-th buyer distribution participation information upon the partial completion of distributing the ownership of the collectable by the k-th buyer among the first buyer 400-1 to the n-th buyer 400-n, may (i) (i-1) broadcast, to the blockchain network 200, the ownership transferal transaction which includes the ownership token contract ID, the ownership transferal information, and the third server signature value, wherein the third server signature value is acquired by signing at least one of the ownership token contract ID and the ownership transferal information with the transaction server private key of the online transaction server 100, or (i-2) broadcast, to the blockchain network 200, the ownership transferal transaction which includes the ownership token contract ID, the ownership transferal information, the third server signature value which is acquired by signing the first hash value with the transaction server private key, wherein the first hash value is acquired by hashing at least one of the ownership token contract ID and the ownership transferal information.

Herein, the ownership transferal information includes a k-th multi-signature wallet contract's address and a k-th cardinal number of the ownership tokens to be transferred.

Further, the online transaction server 100 may instruct the blockchain nodes 200-1, 200-2, . . . , 200-n to (i-1) (i-1-1) (i-1-1-1) decrypt the third server signature value by using the transaction server public key of the online transaction server 100, (i-1-1-2) acquire at least one of the ownership token contract ID and the ownership transferal information as a result of said (i-1-1-1), and (i-1-1-3) check whether the acquired at least one of the ownership token contract ID and the ownership transferal information matches with at least one of the ownership token contract ID and the ownership transferal information included in the ownership transferal transaction, to thereby verify the third server signature value, or (i-1-2) (i-1-2-1) decrypt the third server signature value by using the transaction server public key, (i-1-2-2) acquire the first hash value as a result of said (i-1-2-1), (i-1-2-3) generate the second hash value by hashing at least one of the ownership token contract ID and the ownership transferal information, and (i-1-2-4) check whether the first hash value matches with the second hash value, to thereby verify the third server signature value.

Furthermore, in response to verifying the third server signature value, the online transaction server 100 may instruct the blockchain nodes 200-1, 200-2, . . . , 200-n to execute the ownership token contract to transfer the k-th cardinal number of the ownership tokens to be transferred to the k-th multi-signature wallet contract's address, and repeat the above processes until the ownership distribution of the collectable is finished, to thereby transfer the first cardinal number of the ownership tokens to be transferred to the n-th cardinal number of the ownership tokens to be transferred respectively to the first multi-signature wallet contract's address to the n-th multi-signature wallet contract's address.

Moreover, in response to acquiring the transfer complete information indicating that the ownership tokens have been transferred to the k-th buyer participating in the ownership distribution, the online transaction server 100 may (i) send the transfer complete information to the k-th buyer, (ii) check whether the distribution of the whole of the collectable is completed, and (iii) if the distribution of the whole of the collectable is not completed, repeat the above process for other specific buyers until the ownership distribution of the collectable is finished, and send the settled distributed price information to the owner 300.

It is appreciated that any one of the buyers who received the ownership tokens may hand over his or her ownership tokens to the new buyer 500.

That is, the online transaction server 100 may (i) send the ownership tokens to the first multi-signature wallet contract to the n-th multi-signature wallet contract through the blockchain network 200, to thereby allow the specific buyer 400-k among the first buyer 400-1 to the n-th buyer 400-n who received an ownership token transferal request from the new buyer 500, at a step of S701, to send an ownership token handover request corresponding to the ownership token transferal request to the online transaction server 100, at a step of S702.

Herein, the ownership token transferal request sent to the specific buyer 400-k from the new buyer 500 may include information on the new buyer 500 for generating a new multi-signature wallet contract corresponding to the new buyer 500.

Additionally, the ownership token handover request sent to the online transaction server 100 from the specific buyer 400-k may include information on the specific buyer 400-k, which includes information on the specific multi-signature wallet contract, and information on the new buyer 500.

Further, in response to acquiring the ownership token handover request, the online transaction server 100 may check whether a specific multi-signature wallet contract ID corresponding to the specific multi-signature wallet contract exists by referring to the information on the specific buyer 400-k, and broadcast the specific multi-signature wallet contract ID to the blockchain network 200, to thereby look up a balance of the ownership tokens owned by the specific buyer 400-k.

Furthermore, in response to checking the balance of the ownership tokens of the specific buyer 400-k, the online transaction server 100 may (i) generate the new multi-signature wallet contract for handing over the ownership tokens to the new buyer 500 by referring to the ownership token handover request, at a step of S703, (ii) generate a new multi-signature wallet contract registering transaction which includes the new multi-signature wallet contract and the fourth server signature value, which is a signature value of the online transaction server 100, at a step of S704, and (iii) broadcast the new multi-signature wallet contract registering transaction to the blockchain network 200, at a step of S705.

Moreover, the online transaction server 100 may instruct the blockchain nodes 200-1, 200-2, . . . , 200-n to (i-1) verify the fourth server signature value, at a step of S706, (i-2) in response to verifying the fourth server signature value, register the new multi-signature wallet contract included in the new multi-signature wallet contract registering transaction to the blockchain network 200, at a step of S707, and (iv-3) transfer the new multi-signature wallet contract ID corresponding to the new multi-signature wallet contract registered in the blockchain network 200 to the online transaction server 100, at a step of S708.

In addition, upon saving the new multi-signature wallet contract ID, the online transaction server 100 may generate an ownership token transferal task submission transaction, at a step of S709, which includes the ownership token contract ID, a new multi-signature wallet contract's address, the new cardinal number of ownership tokens to be transferred, and the fifth server signature value which is acquired by signing (i-1) at least one of the ownership token contract ID, the new multi-signature wallet contract's address, and the new cardinal number of ownership tokens to be transferred with the transaction server private key of the online transaction server 100, or (i-2) the at least one third hash value of at least one of the ownership token contract ID, the new multi-signature wallet contract's address, and the new cardinal number of ownership tokens to be transferred with the transaction server private key, to thereby broadcast the ownership token transferal task submission transaction to the blockchain network 200, at a step of S710.

Further, the online transaction server 100 may instruct the blockchain nodes 200-1, 200-2, . . . , 200-n to (i-1) (i-1-1) decrypt the fifth server signature value by using the transaction server public key of the online transaction server 100, (i-1-2) acquire at least one of the ownership token contract ID, the new multi-signature wallet contract's address, and the new cardinal number of ownership tokens to be transferred as a result of said (i-1-1), and (i-1-3) check whether the acquired at least one of the ownership token contract ID, the new multi-signature wallet contract's address, and the new cardinal number of ownership tokens to be transferred matches with at least one of the ownership token contract ID, the new multi-signature wallet contract's address, and the new cardinal number of ownership tokens to be transferred included in the ownership token transferal task submission transaction, to thereby verify the fifth server signature value, or (i-2) (i-2-1) decrypt the fifth server signature value by using the transaction server public key, (i-2-2) acquire the third hash value as a result of said (i-2-1), (i-2-3) generate the fourth hash value by hashing at least one of the ownership token contract ID, the new multi-signature wallet contract's address, and the new cardinal number of ownership tokens to be transferred, and (i-2-4) check whether the third hash value matches with the fourth hash value, to thereby verify the fifth server signature value, at a step of S711.

Furthermore, upon acquiring an ownership token transferal task submission transaction ID, at a step of S712, the online transaction server 100 may (i) request each of a first multi-signer to an m-th multi-signer to multi-sign the ownership token transferal task submission transaction ID corresponding to the ownership token transferal task submission transaction, at a step of S713, (ii) generate each of ownership token transferal task approval transactions, at a step of S714, which includes each of a first multi-signer transferal signature value to a j-th multi-signer transferal signature value and the ownership token transferal task submission transaction ID, wherein each of the first multi-signer transferal signature value to the j-th multi-signer transferal signature value is acquired by signing (ii-1) the ownership token transferal task submission transaction ID with each of multi-signer private keys of the first multi-signer to a j-th multi-signer, or (ii-2) the fifth hash value of the ownership token transferal task submission transaction ID with each of the multi-signer private keys of the first multi-signer to the j-th multi-signer, (iii) send each of the ownership token transferal task approval transactions from each of the first multi-signer to the j-th multi-signer to the blockchain network 200, at a step of S715, and (iv) instruct the blockchain nodes 200-1, 200-2, . . . , 200-n to (iv-1) (iv-1-1) (iv-1-1-1) decrypt the first multi-signer transferal signature value to the j-th multi-signer transferal signature value by using each of multi-signature public keys of the first multi-signer to the j-th multi-signer, (iv-1-1-2) acquire the ownership token transferal task submission transaction ID as a result of said (iv-1-1-1) and, (iv-1-1-3) check whether the acquired ownership token transferal task submission transaction ID matches with the ownership token transferal task submission transaction ID included in each of the ownership token transferal task approval transactions, to thereby verify the first multi-signer transferal signature value to the j-th multi-signer transferal signature value, at a step of S716, or (iv-1-2) (iv-1-2-1) decrypt the first multi-signer transferal signature value to the j-th multi-signer transferal signature value by using each of the multi-signature public keys, (iv-1-2-2) acquire the fifth hash value as a result of said (iv-1-2-1), (iv-1-2-3) generate the sixth hash value by hashing the ownership token transferal task submission transaction ID, and (iv-1-2-4) check whether the fifth hash value matches with the sixth hash value, to thereby verify the first multi-signer transferal signature value to the j-th multi-signer transferal signature value included in each of the ownership token transferal task approval transactions, at the step of S716. Herein, m is an integer greater than 0 and j is an integer greater than 0 and less than m,

It is appreciated that the ownership token transferal task submission transaction ID may be a hash value of the ownership token transferal task submission transaction. Also, the online transaction server 100 may acquire the ownership token transferal task submission transaction ID from the blockchain network 200, but it is not limited to thereto, and the online transaction server 100 may acquire the ownership token transferal task submission transaction ID by hashing the ownership token transferal task submission transaction.

Moreover, the online transaction server 100, in response to verifying the fifth server signature value to be valid and in response to checking that a cardinal number of multi-signer transferal signature values verified to be valid among the first multi-signer transferal signature value to the j-th multi-signer transferal signature value is greater than a predetermined number, may execute the specific multi-signature wallet contract corresponding to the specific buyer 400-k, at a step of S717, to thereby transfer the new cardinal number of ownership tokens to be transferred to the new multi-signature wallet contract's address according to the ownership token contract, at a step of S718.

It is appreciated that the description above details a process of the online transaction server 100 generating the ownership token transferal task submission transaction, and one or more multi-signers multi-signing the ownership token transferal transaction ID, however, it is not limited thereto.

That is, the ownership token transferal task submission transaction may be generated not only by the online transaction server 100 but also by a part of multi-signers, or the specific buyer 400-k. As an example, for a case of generating the ownership token transferal task submission transaction by the specific buyer 400-k, at least part of the online transaction server 100 and multi-signers may multi-sign. As another example, for a case of generating the ownership token transferal task submission transaction by the multi-signers, at least part of the online transaction server 100 and the specific buyer 400-k may multi-sign.

In addition, the online transaction server 100 may instruct the blockchain nodes 200-1, 200-2, . . . , 200-n to transfer the ownership tokens to the new multi-signature wallet contract's address and send transfer complete information from the specific buyer 400-k to the new buyer 500, to thereby allow the new buyer 500 to check the information on the ownership tokens owned by the new buyer 500 from the blockchain network 200 by using the transfer complete information.

Specifically, the online server 100, in response to a request from the new buyer 500 for ownership token balance checking of the new multi-signature wallet contract's address being broadcasted to the blockchain network 200, may instruct the blockchain nodes 200-1, 200-2, 200-n to execute the ownership token contract, to thereby generate the ownership token balance information corresponding to the request for ownership token balance checking, and send the ownership token balance information to the new buyer 500.

It is appreciated that the termination procedures for the ownership tokens and the sale price settlement procedures for the first buyer 400-1 to the n-th buyer 400-n may occur when the sale of the collectable per se takes place, given that each of the first buyer 400-1 to the n-th buyer 400-n holds each of his or hers own ownership tokens.

That is, the online transaction server 100, in response to acquiring sale completion information, may (i) generate the ownership token termination task submission transaction, at a step of S801, which includes the ownership token contract ID and a sixth server signature value which is acquired by (i-1) signing the ownership token contract ID with the transaction server private key of the online transaction server 100 or (i-2) signing the seventh hash value of the ownership token contract ID with the transaction server private key, by referring to the sale complete information, to thereby broadcast the ownership token termination task submission transaction to the blockchain network 200, at a step of S802, and (ii) instruct the blockchain nodes 200-1, 200-2, . . . , 200-n to (ii-1) (ii-1-1) decrypt the sixth server signature value by using the transaction server public key of the online transaction server 100, (ii-1-2) acquire the ownership token contract ID as a result of said (ii-1-1), and (ii-1-3) check whether the acquired ownership token contract ID matches with the ownership token contract ID included in the ownership token termination task submission transaction, to thereby verify the sixth server signature value, at a step of S803, or (ii-2) (ii-2-1) decrypt the sixth server signature value by using the transaction public key, (ii-2-2) acquire the seventh hash value as a result of (ii-2-1), (ii-2-3) generate the eighth hash value by hashing the ownership token contract ID, and (ii-2-4) check whether the seventh hash value matches with the eighth hash value, to thereby verify the sixth server signature value, at the step of S803.

Further, in response to acquiring the ownership token termination task submission transaction, at a step of S804, the online transaction server 100 may (i) request each of the first multi-signer to the m-th multi-signer to multi-sign an ownership token termination task submission transaction ID corresponding to the ownership token termination task submission transaction, at a step of S805, (ii) generate each of ownership token termination task approval transactions, at a step of S806, which includes each of a first multi-signer termination signature value to a j-th multi-signer termination signature value and the ownership token termination task submission transaction ID, wherein each of the first multi-signer termination signature value to the j-th multi-signer termination signature value is acquired by signing (ii-1) the ownership token termination task submission transaction ID with each of the multi-signer private keys of the first multi-signer to the j-th multi-signer, or (ii-2) the ninth hash value of the ownership token termination task submission transaction ID with each of the multi-signer private keys of the first multi-signer to the j-th multi-signer, (iii) broadcast each of the ownership token termination task approval transactions from each of the first multi-signer to the j-th multi-signer to the blockchain network 200, at a step of S807, and (iv) instruct the blockchain nodes 200-1, 200-2, . . . , 200-n to (iv-1) (iv-1-1) (iv-1-1-1) decrypt the first multi-signer termination signature value to the j-th multi-signer termination signature value by using each of the multi-signature public keys of the first multi-signer to the j-th multi-signer, (iv-1-1-2) acquire the ownership token termination task submission transaction ID as a result of said (iv-1-1-1) and, (iv-1-1-3) check whether the acquired ownership token termination task submission transaction ID matches with the ownership token termination task submission transaction ID included in each of the ownership token termination task approval transactions, to thereby verify the first multi-signer termination signature value to the j-th multi-signer termination signature value, at a step of S808, or (iv-1-2) (iv-1-2-1) decrypt the first multi-signer termination signature value to the j-th multi-signer termination signature value by using each of the multi-signature public keys, (iv-1-2-2) acquire the ninth hash value as a result of said (iv-1-2-1), (iv-1-2-3) generate the tenth hash value by hashing the ownership token termination task submission transaction ID, and (iv-1-2-4) check whether the ninth hash value matches with the tenth hash value, to thereby verify each of the first multi-signer termination signature value to the j-th multi-signer termination signature value included in each of the ownership token termination task approval transactions, at the step of S808, and (iv-2) in response to verifying the sixth server signature value to be valid and in response to checking that the cardinal number of multi-signer termination signature values verified to be valid among the first multi-signer termination signature value to the j-th multi-signer termination signature value is greater than or equal to the predetermined number, execute the first multi-signature wallet contract to the n-th multi-signature wallet contract, at a step of S809, to thereby terminate the ownership tokens according to the ownership token contract, at a step of S810.

Herein, the cardinal number of ownership tokens to be terminated may be additionally included in the token termination transaction, and the sixth server signature value may be (i) acquired by signing at least one of the ownership token contract ID, and the cardinal number of ownership tokens to be terminated with the transaction server private key, or (ii) acquired by signing the seventh hash value with the transaction server private key, wherein the seventh hash value is acquired by hashing at least one of the ownership token contract ID, and the cardinal number of ownership tokens to be terminated.

It is appreciated that the ownership token termination task submission transaction ID may be a hash value of the ownership token termination task submission transaction. Also, the online transaction server 100 may acquire the ownership token termination task submission transaction ID from the blockchain network 200, but it is not limited thereto, and may acquire the ownership token termination task submission transaction ID by performing hashing.

It is appreciated that the description above details a process of the online transaction server 100 generating the ownership token termination task submission transaction, and one or more multi-signers multi-signing the ownership token termination transaction ID, however, it is not limited thereto.

That is, the ownership token termination task submission transaction may be generated not only by the online transaction server 100 but also by a part of multi-signers, or the specific buyer 400-k. As an example, for a case of generating the ownership token termination task submission transaction by the specific buyer 400-k, at least part of the online transaction server 100 and multi-signers may multi-sign. As another example, for a case of generating the ownership token termination task submission transaction by the multi-signers, at least part of the online transaction server 100 and the specific buyer 400-k may multi-sign.

It is appreciated that when the sale of the collectable per se takes place, the payment transaction between the purchaser willing to purchase the collectable per se and the online transaction server 100 may be made via account transfer, credit card, and third-party payment, etc., and the online transaction server 100 may settle the sale price for the first buyer 400-1 to the n-th buyer 400-n by performing the sale price settlement procedures, but it is not limited thereto.

For example, if the purchaser willing to purchase the collectable per se is trying to make payment via cryptocurrencies, the cryptocurrencies will not get transferred to the first buyer 400-1 to the n-th buyer 400-n through the online transaction server 100, but instead get transferred to the escrow wallet on the blockchain network 200, where the smart contract can be executed to transfer the cryptocurrencies stored in the escrow wallet to the first buyer 400-1 to the n-th buyer 400-n.

The present disclosure has an effect of allowing multiple participants to jointly own the ownership of the collectable, in a similar way to owning stocks, and to store and manage each of distributed ownerships in a form of tokens on a blockchain.

The present disclosure has another effect of allowing each of the distributed ownerships to be transferred in the form of the tokens.

The present disclosure has still another effect of distributing a sale profit according to a ratio of the tokens owned by the participants when the collectable per se is sold.

The present disclosure has still yet another effect of allowing the third party to manage a digital wallet of the token owner on behalf of the token owner.

The present disclosure has still yet another effect of preventing an erroneous transaction by allowing an ownership token transaction to require the multi-signatures from each of the multi-signers.

The present disclosure has still yet another effect of proposing a method for managing the distributed ownerships and a profit distribution system in connection therewith based on the blockchain, to thereby provide a safe, reliable, and efficient online collectable transacting environment.

Besides, the embodiments of the present disclosure as explained above can be implemented in a form of executable program command through a variety of computer means recordable to computer readable media. The computer readable media may include solely or in combination, program commands, data files, and data structures. The program commands recorded to the media may be components specially designed for the present disclosure or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands may include not only a machine language code made by a complier but also a high level code that can be used by an interpreter etc., which is executed by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for distributing collectable ownership based on blockchain networks, comprising steps of:
(a) an online transaction server, in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; and
(b) the online transaction server, in response to acquiring each piece of ownership distribution participation information for participating in an ownership distribution of the collectable from each of a first buyer to an n-th buyer, wherein n is an integer equal to or larger than 1, according to an ownership distribution participation request for the collectable registered to distribute the ownership of the collectable, (i) requesting each of a first administrator to an m-th administrator, wherein m is an integer equal to or larger than 1, to sign at least one of the ownership token contract ID and ownership transferal information corresponding to the ownership distribution participation information, and (ii) in response to acquiring each of a first administrator signature value to a k-th administrator signature value, which is a signature value acquired by signing at least one of the ownership token contract ID and the ownership transferal information or at least one first hash value of at least one of the ownership token contract ID and the ownership transferal information with each of private keys from each of the first administrator to a k-th administrator, wherein k is an integer equal to or larger than 1 and equal to or less than m, (ii-1) generating an ownership transferal transaction which includes the ownership token contract ID, the ownership transferal information acquired by referring to the ownership distribution participation information, a second server signature value, which is a signature value of the online transaction server, and the first administrator signature value to the k-th administrator signature value, and (ii-2) broadcasting the ownership transferal transaction to the blockchain network, to thereby instruct the blockchain nodes of the blockchain network to (ii-2-1) verify the second server signature value and the first administrator signature value to the k-th administrator signature value, and (ii-2-2) in response to verifying the second server signature value and the first administrator signature value to the k-th administrator signature value, execute the ownership token contract corresponding to the ownership token contract ID and thus transfer ownership tokens corresponding to the collectable to the first buyer to the n-th buyer who have participated in the ownership distribution according to the ownership transferal information.

2. The method of claim 1, wherein, at the step of (b), the online transaction server, in response to acquiring the ownership distribution participation information which includes first buyer distribution participation information and n-th buyer distribution participation information from the first buyer to the n-th buyer upon a completion of distributing the ownership of the collectable, (i) requests each of the first administrator to the m-th administrator to sign at least one of the ownership token contract ID and the ownership transferal information, wherein the ownership transferal information includes a first buyer's digital wallet address to an n-th buyer's digital wallet address and a first cardinal number of the ownership tokens to be transferred to an n-th cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the first cardinal number of the ownership tokens to be transferred to the n-th cardinal number of the ownership tokens to be transferred respectively to the first buyer's digital wallet address to the n-th buyer's digital wallet address.

3. The method of claim 1, wherein, at the step of (b), the online transaction server, in response to acquiring the ownership distribution participation information which includes specific buyer distribution participation information upon a partial completion of distributing the ownership of the collectable by a specific buyer among the first buyer to the n-th buyer, (i) requests each of the first administrator to the m-th administrator to sign at least one of the ownership token contract ID and the ownership transferal information, wherein the ownership transferal information includes a specific buyer's digital wallet address and a specific cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the specific cardinal number of the ownership tokens to be transferred to the specific digital wallet address.

4. The method of claim 1, wherein the ownership token contract includes information on an ownership token structure and an ownership token function corresponding to the collectable,
wherein the ownership token structure includes information on the collectable, information on an ownership token ID, and a cardinal number of issued ownership tokens,
wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and
wherein the ownership token function includes at least part of an ownership token transferal function, an ownership token termination function, an ownership token balance checking function, an ownership token transfer history tracking function, an ownership token restriction function, an ownership token lookup function, an ownership token holder lookup function, an administrator address registering function, and a multi-signature values verifying function.

5. The method of claim 1, further comprising a step of:
(c) the online transaction server (i) allowing transferring of the ownership tokens to the first buyer to the n-th buyer through the blockchain network, (ii) allowing a specific buyer among the first buyer to the n-th buyer who received an ownership token transferal request from a new buyer to (ii-1) generate an ownership token transferal transaction which includes the ownership token contract ID, a new buyer's digital wallet address, a new cardinal number of the ownership tokens to be transferred, and a specific buyer signature value which is acquired by signing (ii-1-1) at least one of the ownership token contract ID, the new buyer's digital wallet address, and the new cardinal number of the ownership tokens to be transferred with a specific buyer private key of the specific buyer, or (ii-1-2) at least one third hash value of at least one of the ownership token contract ID, the new buyer's digital wallet address, and the new cardinal number of ownership tokens to be transferred with the specific buyer private key of the specific buyer, (ii-2) request the online transaction server to multi-sign (ii-2-1) at least one of the ownership token contract ID, the new buyer's digital wallet address, and the new cardinal number of the ownership tokens to be transferred with each of the private keys from each of the first administrator to the k-th administrator, or (ii-2-2) the third hash value of at least one of the ownership token contract ID, the new buyer's digital wallet address, and the new cardinal number of ownership tokens to be transferred with each of the private keys from each of the first administrator to the k-th administrator, to thereby acquire multi-signature values which include a first administrator transferal signature value to a k-th administrator transferal signature value from the first administrator to the k-th administrator, and thus (ii-3) broadcast an ownership token transferal request, which includes the ownership token transferal transaction and the multi-signature values, to the blockchain network, and (iii) instructing the blockchain nodes which received the ownership token transferal request to (iii-1) (iii-1-1) (iii-1-1-1) decrypt the specific buyer signature value and the first administrator transferal signature value to the k-th administrator transferal signature value by using a specific buyer public key of the specific buyer and each of the public keys of the first administrator to the k-th administrator, (iii-1-1-2) acquire at least one of the ownership token contract ID, the new buyer's digital wallet address and the new cardinal number of the ownership tokens to be transferred as a result of said (iii-1-1-1), and (iii-1-1-3) check whether the acquired at least one of the ownership token contract ID, the new buyer's digital wallet address, and the new cardinal number of the ownership tokens to be transferred matches with the at least one of the ownership token contract ID, the new buyer's digital wallet address, and the new cardinal number of the ownership tokens to be transferred included in the ownership token transferal request, to thereby verify the specific buyer signature value and the first administrator transferal signature value to the k-th administrator transferal signature value, or (iii-1-2) (iii-1-2-1) decrypt the specific buyer signature value and the first administrator transferal signature value to the k-th administrator transferal signature value by using the specific buyer public key of the specific buyer and each of the public keys of the first administrator to the k-th administrator, (iii-1-2-2) acquire the third hash value as a result of said (iii-1-2-1), (iii-1-2-3) generate a fourth hash value by hashing at least one of the ownership token contract ID, the new buyer's digital wallet address, and the new cardinal number of the ownership tokens to be transferred, and (iii-1-2-4) check whether the third hash value matches with the fourth hash value, to thereby verify the specific buyer signature value and the first administrator transferal signature value to the k-th administrator transferal signature value, and (iii-2) in response to verifying the specific buyer signature value and the first administrator transferal signature value to the k-th administrator transferal signature value, execute the ownership token contract, to thereby transfer the new cardinal number of the ownership tokens to be transferred to the new buyer's digital wallet address.

6. The method of claim 1, further comprising a step of:
(d) the online transaction server, in response to acquiring sale completion information, (i) sending an ownership token collection request to the first buyer to the n-th buyer for liquidating the ownership tokens corresponding to the collectable, (ii) allowing the first buyer to the n-th buyer to (ii-1) generate each of a first ownership token return transaction to an n-th ownership token return transaction which includes the ownership token contract ID, a transaction server's digital wallet address corresponding to the online transaction server, a first cardinal number of the ownership tokens to be returned to an n-th cardinal number of the ownership tokens to be returned, and each of a first buyer signature value to an n-th buyer signature value which is acquired by signing at least one of the ownership token contract ID, the transaction server's digital wallet address, the first cardinal number of the ownership tokens to be returned to the n-th cardinal number of the ownership tokens to be returned with each of a first buyer private key to an n-th buyer private key corresponding to each of the first buyer to the n-th buyer, to thereby broadcast the first ownership token return transaction to the n-th ownership token return transaction to the blockchain network, or (ii-2) generate each of the first ownership token return transaction to the n-th ownership token return transaction which includes the ownership token contract ID, the transaction server's digital wallet address, the first cardinal number of the ownership tokens to be returned to the n-th cardinal number of the ownership tokens to be returned, and each of the first buyer signature value to the n-th buyer signature value which is acquired by signing a fifth hash value with each of the first buyer private key to the n-th buyer private key, wherein the fifth hash value is acquired by hashing at least one of the ownership token contract ID, the transaction server's digital wallet address, and the first cardinal number of the ownership tokens to be returned to the n-th cardinal number of the ownership tokens to be returned, to thereby broadcast the first ownership token return transaction to the n-th ownership token return transaction to the blockchain network, and (iii) instructing the blockchain nodes to (iii-1) (iii-1-1) (iii-1-1-1) decrypt the first buyer signature value to the n-th buyer signature value by using the first buyer public key to the n-th buyer public key corresponding to the first buyer to the n-th buyer, (iii-1-1-2) acquire at least one of the ownership token contract ID, the transaction server's digital wallet address, and the first cardinal number of the ownership tokens to be returned to the n-th cardinal number of the ownership tokens to be returned as a result of said (iii-1-1-2), and (iii-1-1-3) check whether the acquired at least one of the ownership token contract ID, the transaction server's digital wallet address, and the first cardinal number of the ownership tokens to be returned to the n-th cardinal number of the ownership tokens to be returned matches with at least one of the ownership token contract ID, the transaction server's digital wallet address, and the first cardinal number of the ownership tokens to be returned to the n-th cardinal number of the ownership tokens to be returned included in the first ownership token return transaction to the n-th ownership token return transaction, to thereby verify the first buyer signature value to the n-th buyer signature value, or (iii-1-2) (iii-1-2-1) decrypt the first buyer signature value to the n-th buyer signature value by using the first buyer public key to the n-th buyer public key, (iii-1-2-2) acquire the fifth hash value as a result of said (iii-1-2-1), (iii-1-2-3) generate a sixth hash value by hashing at least one of the ownership token contract ID, the transaction server's digital wallet address, and the first cardinal number of the ownership tokens to be returned to the n-th cardinal number of the ownership tokens to be returned, and (iii-1-2-4) check whether the fifth hash value matches with the sixth hash value, to thereby verify the first buyer signature value to the n-th buyer signature value, and (iii-2) in response to verifying the first buyer signature value to the n-th buyer signature value, execute the ownership token contract, to thereby transfer the first cardinal number of the ownership tokens to be returned to the n-th cardinal number of the ownership tokens to be returned to the transaction server's digital wallet address.

7. The method of claim 6, further comprising a step of:
(e) the online transaction server, in response to collecting the ownership tokens from the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one seventh hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a third server signature value, and the first administrator termination signature value to the k-th administrator termination signature value, wherein the third server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the third server signature value and the first administrator termination signature value to the k-th administrator termination signature value, wherein the third server signature value is acquired by signing the seventh hash value with the transaction server private key, and wherein the seventh hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the third server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the third server signature value and the first administrator termination signature value to the k-th administrator termination signature value, or (iv-1-2) (iv-1-2-1) decrypt the third server signature value and the first administrator termination signature value to the k-th administrator termination signature value by using the transaction server public key and each of the public keys of the first administrator to the k-th administrator, (iv-2-2) acquire the seventh hash value as a result of said (iv-1-2-1), (iv-1-2-3) generate an eighth hash value by hashing at least one of the ownership token contract ID and the transaction server's digital wallet address, and (iv-1-2-4) check whether the seventh hash value matches with the eighth hash value, to thereby verify the third server signature value and the first administrator termination signature value to the k-th administrator termination signature value, and (iv-2) in response to verifying the third server signature value and the first administrator termination signature value to the k-th administrator termination signature value, execute the ownership token contract, to thereby terminate the ownership tokens transferred from the first buyer to the n-th buyer.

8. The method of claim 6, further comprising a step of:
(f) the online transaction server, in response to collecting specific ownership tokens from a specific buyer among the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one ninth hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a fourth server signature value, and the first administrator termination signature value to the k-th administrator termination signature value, wherein the fourth server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the fourth server signature value and the first administrator termination signature value to the k-th administrator termination signature value, wherein the fourth server signature value is acquired by signing the ninth hash value with the transaction server private key, and wherein the ninth hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the fourth server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the fourth server signature value and the first administrator termination signature value to the k-th administrator termination signature value, or (iv-1-2) (iv-1-2-1) decrypt the fourth server signature value and the first administrator termination signature value to the k-th administrator termination signature value by using the transaction server public key and each of the public keys of the first administrator to the k-th administrator, (iv-1-2-2) acquire the ninth hash value as a result of said (iv-1-2-1), (iv-1-2-3) generate a tenth hash value by hashing at least one of the ownership token contract ID and the transaction server's digital wallet address, and (iv-1-2-4) check whether the ninth hash value matches with the tenth hash value, to thereby verify the fourth server signature value and the first administrator termination signature value to the k-th administrator termination signature value, and (iv-2) in response to verifying the fourth server signature value and the first administrator termination signature value to the k-th administrator termination signature value, execute the ownership token contract, to thereby terminate the specific ownership tokens transferred from the specific buyer among first buyer to the n-th buyer.

9. A method for distributing collectable ownership based on blockchain networks, comprising:
(a) an online transaction server, in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server;
(b) the online transaction server, in response to acquiring each piece of ownership distribution participation information for participating in an ownership distribution of the collectable from each of a first buyer to an n-th buyer, wherein n is an integer greater than or equal to 1, according to an ownership distribution participation request for the collectable registered to distribute the ownership of the collectable, (i) generating each of a first multi-signature wallet contract to an n-th multi-signature wallet contract in order to distribute ownership tokens to each of the first buyer to the n-th buyer, (ii) generating at least one multi-signature wallet contract registering transaction which includes each of the first multi-signature wallet contract to the n-th multi-signature wallet contract and a second server signature value, which is a signature value of the online transaction server, and (iii) broadcasting the at least one multi-signature wallet contract registering transaction to the blockchain network, to thereby instruct the blockchain nodes of the blockchain network to (iii-1) verify the second server signature value, (iii-2) in response to verifying the second server signature value, register the first multi-signature wallet contract to the n-th multi-signature wallet contract included in the multi-signature wallet contract registering transaction in the blockchain network, and (iii-3) transfer a first multi-signature wallet contract ID to an n-th multi-signature wallet contract ID corresponding to the first multi-signature wallet contract to the n-th multi-signature wallet contract registered in the blockchain network to the online transaction server; and
(c) the online transaction server (i) generating an ownership transferal transaction which includes the ownership token contract ID, ownership transferal information acquired by referring to the ownership distribution participation information, and a third server signature value which is a signature value acquired by signing (i-1) at least one of the ownership token contract ID and the ownership transferal information with a transaction server private key of the online transaction server, or (i-2) at least one first hash value of at least one of the ownership token contract ID and the ownership transferal information, and (ii) broadcasting the ownership transferal transaction to the blockchain network, to thereby instruct the blockchain nodes of the blockchain network to (ii-1) verify the third server signature value, and (ii-2) in response to verifying the third server signature value, execute the ownership token contract corresponding to the ownership token contract ID and thus transfer each of the ownership tokens corresponding to the collectable to each of the first multi-signature wallet contract to the n-th multi-signature wallet contract corresponding to each of the first buyer to the n-th buyer who have participated in the ownership distribution according to the ownership transferal information.

10. The method of claim 9, wherein, at the step of (c), the online transaction server, in response to acquiring the ownership distribution participation information which includes first buyer distribution participation information to n-th buyer distribution participation information from the first buyer to the n-th buyer upon a completion of distributing the ownership of the collectable, (i) (i-1) broadcasts, to the blockchain network, the ownership transferal transaction which includes the ownership token contract ID, the ownership transferal information, and the third server signature value, wherein the ownership transferal information includes a first multi-signature wallet contract's address to an n-th multi-signature wallet contract's address and a first cardinal number of the ownership tokens to be transferred to an n-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, and the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract, to thereby transfer the first cardinal number of the ownership tokens to be transferred to the n-th cardinal number of the ownership tokens to be transferred respectively to the first multi-signature wallet contract's address to the n-th multi-signature wallet contract's address.

11. The method of claim 9, wherein, at the step of (c), the online transaction server, in response to acquiring the ownership distribution participation information which includes k-th buyer distribution participation information upon a partial completion of distributing the ownership of the collectable by a k-th buyer among the first buyer to the n-th buyer, (i) (i-1) broadcasts, to the blockchain network, the ownership transferal transaction which includes the ownership token contract ID, the ownership transferal information, and the third server signature value, wherein the ownership transferal information includes a k-th multi-signature wallet contract's address and a k-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract to transfer the k-th cardinal number of the ownership tokens to be transferred to the k-th multi-signature wallet contract's address, to thereby transfer the first cardinal number of the ownership tokens to be transferred to the n-th cardinal number of the ownership tokens to be transferred respectively to the first multi-signature wallet contract's address to the n-th multi-signature wallet contract's address.

12. The method of claim 9, wherein the ownership token contract includes information on an ownership token structure and an ownership token function corresponding to the collectable,
wherein the ownership token structure includes information on the collectable, information on an ownership token ID, and a cardinal number of issued ownership tokens,
wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and
wherein the ownership token function includes at least part of an ownership token transferal function, an ownership token termination function, an ownership token balance checking function, an ownership token transfer history tracking function, an ownership token restriction function, an ownership token lookup function, and an ownership token holder lookup function.

13. The method of claim 9, further comprising steps of:
(d1) the online transaction server (i) sending the ownership tokens to the first multi-signature wallet contract to the n-th multi-signature wallet contract through the blockchain network, to thereby allow a specific buyer among the first buyer to the n-th buyer who received an ownership token transferal request from a new buyer to (i-1) send an ownership token handover request corresponding to the ownership token transferal request to the online transaction server, (ii) in response to acquiring the ownership token handover request, generating a new multi-signature wallet contract in order to hand over the ownership tokens to the new buyer by referring to the ownership token handover request, (iii) generating a new multi-signature wallet contract registering transaction which includes the new multi-signature wallet contract and a fourth server signature value, which is a signature value of the online transaction server, and (iv) broadcasting the new multi-signature wallet contract registering transaction to the blockchain network, to thereby instruct the blockchain nodes to (iv-1) verify the fourth server signature value, (iv-2) in response to verifying the fourth server signature value, register the new multi-signature wallet contract included in the new multi-signature wallet contract registering transaction to the blockchain network, and (iv-3) transfer a new multi-signature wallet contract ID corresponding to the new multi-signature wallet contract registered in the blockchain network to the online transaction server; and
(d2) the online transaction server (i) generating an ownership token transferal task submission transaction which includes the ownership token contract ID, a new multi-signature wallet contract's address, a new cardinal number of ownership tokens to be transferred, and a fifth server signature value which is acquired by signing (i-1) at least one of the ownership token contract ID, the new multi-signature wallet contract's address, and the new cardinal number of ownership tokens to be transferred with the transaction server private key, or (i-2) at least one third hash value of at least one of the ownership token contract ID, the new multi-signature wallet contract's address, and the new cardinal number of ownership tokens to be transferred with the transaction server private key, to thereby broadcast the ownership token transferal task submission transaction to the blockchain network, (ii) instructing the blockchain nodes to (ii-1) (ii-1-1) decrypt the fifth server signature value by using a transaction server public key of the online transaction server (ii-1-2) acquire at least one of the ownership token contract ID, the new multi-signature wallet contract's address, and the new cardinal number of ownership tokens to be transferred as a result of said (ii-1-1), and (ii-1-3) check whether the acquired at least one of the ownership token contract ID, the new multi-signature wallet contract's address, and the new cardinal number of ownership tokens to be transferred matches with at least one of the ownership token contract ID, the new multi-signature wallet contract's address, and the new cardinal number of ownership tokens to be transferred included in the ownership token transferal task submission transaction, to thereby verify the fifth server signature value, or (ii-2) (ii-2-1) decrypt the fifth server signature value by using the transaction server public key, (ii-2-2) acquire the third hash value as a result of said (ii-2-1), (ii-2-3) generate a fourth hash value by hashing at least one of the ownership token contract ID, the new multi-signature wallet contract's address, and the new cardinal number of ownership tokens to be transferred, and (ii-2-4) check whether the third hash value matches with the fourth hash value, to thereby verify the fifth server signature value, (iii) requesting each of a first multi-signer to an m-th multi-signer to multi-sign an ownership token transferal task submission transaction ID corresponding to the ownership token transferal task submission transaction, wherein m is an integer greater than or equal to 1, (iv) generating each of ownership token transferal task approval transactions which includes each of a first multi-signer transferal signature value to a j-th multi-signer transferal signature value and the ownership token transferal task submission transaction ID, wherein each of the first multi-signer transferal signature value to the j-th multi-signer transferal signature value is acquired by signing (iv-1) the ownership token transferal task submission transaction ID with each of multi-signer private keys of the first multi-signer to a j-th multi-signer, or (iv-2) a fifth hash value of the ownership token transferal task submission transaction ID with each of the multi-signer private keys of the first multi-signer to the j-th multi-signer, and wherein j is an integer greater than or equal to 1 and less than m, (v) sending each of the ownership token transferal task approval transactions from each of the first multi-signer to the j-th multi-signer to the blockchain network, and (vi) instructing the blockchain nodes to (vi-1) (vi-1-1) (vi-1-1-1) decrypt the first multi-signer transferal signature value to the j-th multi-signer transferal signature value by using each of multi-signature public keys of the first multi-signer to the j-th multi-signer, (vi-1-1-2) acquire the ownership token transferal task submission transaction ID as a result of said (vi-1-1-1) and, (vi-1-1-3) check whether the acquired ownership token transferal task submission transaction ID matches with the ownership token transferal task submission transaction ID included in each of the ownership token transferal task approval transactions, to thereby verify the first multi-signer transferal signature value to the j-th multi-signer transferal signature value, or (vi-1-2) (vi-1-2-1) decrypt the first multi-signer transferal signature value to the j-th multi-signer transferal signature value by using each of the multi-signature public keys, (vi-1-2-2) acquire the fifth hash value as a result of said (vi-1-2-1), (vi-1-2-3) generate a sixth hash value by hashing the ownership token transferal task submission transaction ID, and (vi-1-2-4) check whether the fifth hash value matches with the sixth hash value, to thereby verify the first multi-signer transferal signature value to the j-th multi-signer transferal signature value included in each of the ownership token transferal task approval transactions, and (vi-2) in response to verifying the fifth server signature value to be valid and in response to checking that a cardinal number of multi-signer transferal signature values verified to be valid among the first multi-signer transferal signature value to the j-th multi-signer transferal signature value is greater than a predetermined number, execute a specific multi-signature wallet contract corresponding to the specific buyer, to thereby transfer the new cardinal number of ownership tokens to be transferred to the new multi-signature wallet contract's address according to the ownership token contract.

14. The method of claim 9, further comprising a step of:
(e) the online transaction server, in response to acquiring sale completion information, (i) generating an ownership token termination task submission transaction which includes the ownership token contract ID and a sixth server signature value which is acquired by (i-1) signing the ownership token contract ID with a transaction server private key of the online transaction server or (i-2) signing a seventh hash value of the ownership token contract ID with the transaction server private key, to thereby broadcast the ownership token termination task submission transaction to the blockchain network, (ii) instructing the blockchain nodes to (ii-1) (ii-1-1) decrypt the sixth server signature value by using a transaction server public key of the online transaction server, (ii-1-2) acquire the ownership token contract ID as a result of said (ii-1-1), and (ii-1-3) check whether the acquired ownership token contract ID matches with the ownership token contract ID included in the ownership token termination task submission transaction, to thereby verify the sixth server signature value, or (ii-2) (ii-2-1) decrypt the sixth server signature value by using the transaction public key, (ii-2-2) acquire the seventh hash value as a result of (ii-2-1), (ii-2-3) generate an eighth hash value by hashing the ownership token contract ID, and (ii-2-4) check whether the seventh hash value matches with the eighth hash value, to thereby verify the sixth server signature value, (iii) requesting each of a first multi-signer to an m-th multi-signer to multi-sign an ownership token termination task submission transaction ID corresponding to the ownership token termination task submission transaction, wherein m is an integer greater than or equal to 1, (iv) generating each of ownership token termination task approval transactions which includes each of a first multi-signer termination signature value to a j-th multi-signer termination signature value and the ownership token termination task submission transaction ID, wherein each of the first multi-signer termination signature value to the j-th multi-signer termination signature value is acquired by signing (iv-1) the ownership token termination task submission transaction ID with each of multi-signer private keys of the first multi-signer to the j-th multi-signer, or (iv-2) a ninth hash value of the ownership token termination task submission transaction ID with each of the multi-signer private keys of the first multi-signer to the j-th multi-signer, and wherein j is an integer greater than or equal to 1 and less than m, (v) broadcasting each of the ownership token termination task approval transactions from each of the first multi-signer to the j-th multi-signer to the blockchain network, and (vi) instructing the blockchain nodes to (vi-1) (vi-1-1) (vi-1-1-1) decrypt the first multi-signer termination signature value to the j-th multi-signer termination signature value by using each of multi-signature public keys of the first multi-signer to the j-th multi-signer, (vi-1-1-2) acquire the ownership token termination task submission transaction ID as a result of said (vi-1-1-1) and, (vi-1-1-3) check whether the acquired ownership token termination task submission transaction ID matches with the ownership token termination task submission transaction ID included in each of the ownership token termination task approval transactions, to thereby verify the first multi-signer termination signature value to the j-th multi-signer termination signature value, or (vi-1-2) (vi-1-2-1) decrypt the first multi-signer termination signature value to the j-th multi-signer termination signature value by using each of the multi-signature public keys, (vi-1-2-2) acquire the ninth hash value as a result of said (vi-1-2-1), (vi-1-2-3) generate a tenth hash value by hashing the ownership token termination task submission transaction ID, and (vi-1-2-4) check whether the ninth hash value matches with the tenth hash value, to thereby verify each of the first multi-signer termination signature value to the j-th multi-signer termination signature value included in each of the ownership token termination task approval transactions, and (vi-2) in response to verifying the sixth server signature value to be valid and in response to checking that a cardinal number of multi-signer termination signature values verified to be valid among the first multi-signer termination signature value to the j-th multi-signer termination signature value is greater than or equal to a predetermined number, execute the first multi-signature wallet contract to the n-th multi-signature wallet contract, to thereby terminate the ownership tokens according to the ownership token contract.

15. The method of claim 9, wherein each of the first multi-signature wallet contract to the n-th multi-signature wallet contract includes information on a multi-signature structure and a multi-signature function,
wherein the multi-signature structure includes information on at least part of a cardinal number of people taking part in multi-signature, a minimum number of multi-signatures required to validate a multi-signature, and addresses of multi-signers, and
wherein the multi-signature function includes at least part of an ownership token related task submission function, an ownership token related task approval function, an ownership token related task executing function, a multi-signer adding function, a multi-signer deleting function, and a number changing function for changing the minimum number of multi-signatures.

16. An online transaction server for distributing collectable ownership based on blockchain networks, comprising:
at least one memory that stores instructions; and
at least one processor configured to execute the instructions to perform processes of: (1) in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; and (2) in response to acquiring each piece of ownership distribution participation information for participating in an ownership distribution of the collectable from each of a first buyer to an n-th buyer, wherein n is an integer equal to or larger than 1, according to an ownership distribution participation request for the collectable registered to distribute the ownership of the collectable, (i) requesting each of a first administrator to an m-th administrator, wherein m is an integer equal to or larger than 1, to sign at least one of the ownership token contract ID and ownership transferal information corresponding to the ownership distribution participation information, and (ii) in response to acquiring each of a first administrator signature value to a k-th administrator signature value, which is a signature value acquired by signing at least one of the ownership token contract ID and the ownership transferal information or at least one first hash value of at least one of the ownership token contract ID and the ownership transferal information with each of private keys from each of the first administrator to a k-th administrator, wherein k is an integer equal to or larger than 1 and equal to or less than m, (ii-1) generating an ownership transferal transaction which includes the ownership token contract ID, the ownership transferal information acquired by referring to the ownership distribution participation information, a second server signature value, which is a signature value of the online transaction server, and the first administrator signature value to the k-th administrator signature value, and (ii-2) broadcasting the ownership transferal transaction to the blockchain network, to thereby instruct the blockchain nodes of the blockchain network to (ii-2-1) verify the second server signature value and the first administrator signature value to the k-th administrator signature value, and (ii-2-2) in response to verifying the second server signature value and the first administrator signature value to the k-th administrator signature value, execute the ownership token contract corresponding to the ownership token contract ID and thus transfer ownership tokens corresponding to the collectable to the first buyer to the n-th buyer who have participated in the ownership distribution according to the ownership transferal information.

17. The online transaction server of claim 16, wherein, at the process of (2), the processor, in response to acquiring the ownership distribution participation information which includes first buyer distribution participation information and n-th buyer distribution participation information from the first buyer to the n-th buyer upon a completion of distributing the ownership of the collectable, (i) requests each of the first administrator to the m-th administrator to sign at least one of the ownership token contract ID and the ownership transferal information, wherein the ownership transferal information includes a first buyer's digital wallet address to an n-th buyer's digital wallet address and a first cardinal number of the ownership tokens to be transferred to an n-th cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the first cardinal number of the ownership tokens to be transferred to the n-th cardinal number of the ownership tokens to be transferred respectively to the first buyer's digital wallet address to the n-th buyer's digital wallet address.

18. The online transaction server of claim 16, wherein, at the process of (2), the processor, in response to acquiring the ownership distribution participation information which includes specific buyer distribution participation information upon a partial completion of distributing the ownership of the collectable by a specific buyer among the first buyer to the n-th buyer, (i) requests each of the first administrator to the m-th administrator to sign at least one of the ownership token contract ID and the ownership transferal information, wherein the ownership transferal information includes a specific buyer's digital wallet address and a specific cardinal number of the ownership tokens to be transferred, and (ii) in response to acquiring each of the first administrator signature value to the k-th administrator signature value from each of the first administrator to the k-th administrator, (ii-1) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing at least one of the ownership token contract ID and the ownership transferal information with a transaction server private key of the online transaction server, or (ii-2) broadcasts, to the blockchain network, the ownership transferal transaction which includes the ownership token contract ID, the ownership transferal information, the second server signature value and the first administrator signature value to the k-th administrator signature value, wherein the second server signature value is acquired by signing the first hash value with the transaction server private key, and wherein the first hash value is acquired by hashing at least one of the ownership token contract ID and the ownership transferal information, and (iii) instructs the blockchain nodes to (iii-1) (iii-1-1) (iii-1-1-1) decrypt the second server signature value and the first administrator signature value to the k-th administrator signature value by using a transaction server public key of the online transaction server and each of public keys of the first administrator to the k-th administrator, (iii-1-1-2) acquire at least one of the ownership token contract ID and the ownership transferal information as a result of said (iii-1-1-1), and (iii-1-1-3) check whether the acquired at least one of the ownership token contract ID and the ownership transferal information matches with at least one of the ownership token contract ID and the ownership transferal information included in the ownership transferal transaction, to thereby verify the second server signature value and the first administrator signature value to the k-th administrator signature value, or (iii-1-2) (iii-1-2-1) decrypt the second server signature value and the first administrator signature value to the k-th administrator signature value by using the transaction server public key and each of the public keys of the first administrator to the k-th administrator, (iii-1-2-2) acquire the first hash value as a result of said (iii-1-2-1), (iii-1-2-3) generate a second hash value by hashing at least one of the ownership token contract ID and the ownership transferal information, and (iii-1-2-4) check whether the first hash value matches with the second hash value, to thereby verify the second server signature value and the first administrator signature value to the k-th administrator signature value, and (iii-2) in response to verifying the second server signature value and the first administrator signature value to the k-th administrator signature value, execute the ownership token contract, to thereby transfer the specific cardinal number of the ownership tokens to be transferred to the specific digital wallet address.

19. The online transaction server of claim 16, wherein the ownership token contract includes information on an ownership token structure and an ownership token function corresponding to the collectable,
wherein the ownership token structure includes information on the collectable, information on an ownership token ID, and a cardinal number of issued ownership tokens,
wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and
wherein the ownership token function includes at least part of an ownership token transferal function, an ownership token termination function, an ownership token balance checking function, an ownership token transfer history tracking function, an ownership token restriction function, an ownership token lookup function, an ownership token holder lookup function, an administrator address registering function, and a multi-signature values verifying function.

20. The online transaction server of claim 16, wherein the processor further performs a process of: (3) (i) allowing transferring of the ownership tokens to the first buyer to the n-th buyer through the blockchain network, (ii) allowing a specific buyer among the first buyer to the n-th buyer who received an ownership token transferal request from a new buyer to (ii-1) generate an ownership token transferal transaction which includes the ownership token contract ID, a new buyer's digital wallet address, a new cardinal number of the ownership tokens to be transferred, and a specific buyer signature value which is acquired by signing (ii-1-1) at least one of the ownership token contract ID, the new buyer's digital wallet address, and the new cardinal number of the ownership tokens to be transferred with a specific buyer private key of the specific buyer, or (ii-1-2) at least one third hash value of at least one of the ownership token contract ID, the new buyer's digital wallet address, and the new cardinal number of ownership tokens to be transferred with the specific buyer private key of the specific buyer, (ii-2) request the online transaction server to multi-sign (ii-2-1) at least one of the ownership token contract ID, the new buyer's digital wallet address, and the new cardinal number of the ownership tokens to be transferred with each of the private keys from each of the first administrator to the k-th administrator, or (ii-2-2) the third hash value of at least one of the ownership token contract ID, the new buyer's digital wallet address, and the new cardinal number of ownership tokens to be transferred with each of the private keys from each of the first administrator to the k-th administrator, to thereby acquire multi-signature values which include a first administrator transferal signature value to a k-th administrator transferal signature value from the first administrator to the k-th administrator, and thus (ii-3) broadcast an ownership token transferal request, which includes the ownership token transferal transaction and the multi-signature values, to the blockchain network, and (iii) instructing the blockchain nodes which received the ownership token transferal request to (iii-1) (iii-1-1) (iii-1-1-1) decrypt the specific buyer signature value and the first administrator transferal signature value to the k-th administrator transferal signature value by using a specific buyer public key of the specific buyer and each of the public keys of the first administrator to the k-th administrator, (iii-1-1-2) acquire at least one of the ownership token contract ID, the new buyer's digital wallet address and the new cardinal number of the ownership tokens to be transferred as a result of said (iii-1-1-1), and (iii-1-1-3) check whether the acquired at least one of the ownership token contract ID, the new buyer's digital wallet address, and the new cardinal number of the ownership tokens to be transferred matches with the at least one of the ownership token contract ID, the new buyer's digital wallet address, and the new cardinal number of the ownership tokens to be transferred included in the ownership token transferal request, to thereby verify the specific buyer signature value and the first administrator transferal signature value to the k-th administrator transferal signature value, or (iii-1-2) (iii-1-2-1) decrypt the specific buyer signature value and the first administrator transferal signature value to the k-th administrator transferal signature value by using the specific buyer public key of the specific buyer and each of the public keys of the first administrator to the k-th administrator, (iii-1-2-2) acquire the third hash value as a result of said (iii-1-2-1), (iii-1-2-3) generate a fourth hash value by hashing at least one of the ownership token contract ID, the new buyer's digital wallet address, and the new cardinal number of the ownership tokens to be transferred, and (iii-1-2-4) check whether the third hash value matches with the fourth hash value, to thereby verify the specific buyer signature value and the first administrator transferal signature value to the k-th administrator transferal signature value, and (iii-2) in response to verifying the specific buyer signature value and the first administrator transferal signature value to the k-th administrator transferal signature value, execute the ownership token contract, to thereby transfer the new cardinal number of the ownership tokens to be transferred to the new buyer's digital wallet address.

21. The online transaction server of claim 16, wherein the processor further performs a process of: (4) in response to acquiring sale completion information, (i) sending an ownership token collection request to the first buyer to the n-th buyer for liquidating the ownership tokens corresponding to the collectable, (ii) allowing the first buyer to the n-th buyer to (ii-1) generate each of a first ownership token return transaction to an n-th ownership token return transaction which includes the ownership token contract ID, a transaction server's digital wallet address corresponding to the online transaction server, a first cardinal number of the ownership tokens to be returned to an n-th cardinal number of the ownership tokens to be returned, and each of a first buyer signature value to an n-th buyer signature value which is acquired by signing at least one of the ownership token contract ID, the transaction server's digital wallet address, the first cardinal number of the ownership tokens to be returned to the n-th cardinal number of the ownership tokens to be returned with each of a first buyer private key to an n-th buyer private key corresponding to each of the first buyer to the n-th buyer, to thereby broadcast the first ownership token return transaction to the n-th ownership token return transaction to the blockchain network, or (ii-2) generate each of the first ownership token return transaction to the n-th ownership token return transaction which includes the ownership token contract ID, the transaction server's digital wallet address, the first cardinal number of the ownership tokens to be returned to the n-th cardinal number of the ownership tokens to be returned, and each of the first buyer signature value to the n-th buyer signature value which is acquired by signing a fifth hash value with each of the first buyer private key to the n-th buyer private key, wherein the fifth hash value is acquired by hashing at least one of the ownership token contract ID, the transaction server's digital wallet address, and the first cardinal number of the ownership tokens to be returned to the n-th cardinal number of the ownership tokens to be returned, to thereby broadcast the first ownership token return transaction to the n-th ownership token return transaction to the blockchain network, and (iii) instructing the blockchain nodes to (iii-1) (iii-1-1) (iii-1-1-1) decrypt the first buyer signature value to the n-th buyer signature value by using the first buyer public key to the n-th buyer public key corresponding to the first buyer to the n-th buyer, (iii-1-1-2) acquire at least one of the ownership token contract ID, the transaction server's digital wallet address, and the first cardinal number of the ownership tokens to be returned to the n-th cardinal number of the ownership tokens to be returned as a result of said (iii-1-1-2), and (iii-1-1-3) check whether the acquired at least one of the ownership token contract ID, the transaction server's digital wallet address, and the first cardinal number of the ownership tokens to be returned to the n-th cardinal number of the ownership tokens to be returned matches with at least one of the ownership token contract ID, the transaction server's digital wallet address, and the first cardinal number of the ownership tokens to be returned to the n-th cardinal number of the ownership tokens to be returned included in the first ownership token return transaction to the n-th ownership token return transaction, to thereby verify the first buyer signature value to the n-th buyer signature value, or (iii-1-2) (iii-1-2-1) decrypt the first buyer signature value to the n-th buyer signature value by using the first buyer public key to the n-th buyer public key, (iii-1-2-2) acquire the fifth hash value as a result of said (iii-1-2-1), (iii-1-2-3) generate a sixth hash value by hashing at least one of the ownership token contract ID, the transaction server's digital wallet address, and the first cardinal number of the ownership tokens to be returned to the n-th cardinal number of the ownership tokens to be returned, and (iii-1-2-4) check whether the fifth hash value matches with the sixth hash value, to thereby verify the first buyer signature value to the n-th buyer signature value, and (iii-2) in response to verifying the first buyer signature value to the n-th buyer signature value, execute the ownership token contract, to thereby transfer the first cardinal number of the ownership tokens to be returned to the n-th cardinal number of the ownership tokens to be returned to the transaction server's digital wallet address.

22. The online transaction server of claim 21, wherein the processor further performs a process of: (5) in response to collecting the ownership tokens from the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one seventh hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a third server signature value, and the first administrator termination signature value to the k-th administrator termination signature value, wherein the third server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the third server signature value and the first administrator termination signature value to the k-th administrator termination signature value, wherein the third server signature value is acquired by signing the seventh hash value with the transaction server private key, and wherein the seventh hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the third server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the third server signature value and the first administrator termination signature value to the k-th administrator termination signature value, or (iv-1-2) (iv-1-2-1) decrypt the third server signature value and the first administrator termination signature value to the k-th administrator termination signature value by using the transaction server public key and each of the public keys of the first administrator to the k-th administrator, (iv-2-2) acquire the seventh hash value as a result of said (iv-1-2-1), (iv-1-2-3) generate an eighth hash value by hashing at least one of the ownership token contract ID and the transaction server's digital wallet address, and (iv-1-2-4) check whether the seventh hash value matches with the eighth hash value, to thereby verify the third server signature value and the first administrator termination signature value to the k-th administrator termination signature value, and (iv-2) in response to verifying the third server signature value and the first administrator termination signature value to the k-th administrator termination signature value, execute the ownership token contract, to thereby terminate the ownership tokens transferred from the first buyer to the n-th buyer.

23. The online transaction of claim 21, wherein the processor further performs a process of: (6) in response to collecting specific ownership tokens from a specific buyer among the first buyer to the n-th buyer, (i) requesting each of the first administrator to the m-th administrator to sign at least one of the ownership token contract ID and the transaction server's digital wallet address, (ii) acquiring a first administrator termination signature value to a k-th administrator termination signature value by signing (ii-1) at least one of the ownership token contract ID and the transaction server's digital wallet address with each of the private keys of the first administrator to the k-th administrator from each of the first administrator to the k-th administrator, or (ii-2) at least one ninth hash value of at least one of the ownership token contract ID and the transaction server's digital wallet address with each of the private keys of the first administrator to the k-th administrator, (iii) (iii-1) generating an ownership token termination transaction which includes the ownership token contract ID, the transaction server's digital wallet address, a fourth server signature value, and the first administrator termination signature value to the k-th administrator termination signature value, wherein the fourth server signature value is acquired by signing at least one of the ownership token contract ID and the transaction server's digital wallet address with the transaction server private key of the online transaction server, to thereby broadcast the ownership token termination transaction to the blockchain network, or (iii-2) generating the ownership token termination transaction which includes the ownership token contract ID, the transaction server's digital wallet address, the fourth server signature value and the first administrator termination signature value to the k-th administrator termination signature value, wherein the fourth server signature value is acquired by signing the ninth hash value with the transaction server private key, and wherein the ninth hash value is acquired by hashing at least one of the ownership token contract ID and the transaction server's digital wallet address, to thereby broadcast the ownership token termination transaction to the blockchain network, and (iv) instructing the blockchain nodes to (iv-1) (iv-1-1) (iv-1-1-1) decrypt the fourth server signature value and the first administrator termination signature value to the k-th administrator termination signature value by using the transaction server public key of the online transaction server and each of public keys of the first administrator to the k-th administrator, (iv-1-1-2) acquire at least one of the ownership token contract ID and the transaction server's digital wallet address as a result of said (iv-1-1-1), and (iv-1-1-3) check whether the acquired at least one of the ownership token contract ID and the transaction server's digital wallet address matches with at least one of the ownership token contract ID and the transaction server's digital wallet address included in the ownership token termination transaction, to thereby verify the fourth server signature value and the first administrator termination signature value to the k-th administrator termination signature value, or (iv-1-2) (iv-1-2-1) decrypt the fourth server signature value and the first administrator termination signature value to the k-th administrator termination signature value by using the transaction server public key and each of the public keys of the first administrator to the k-th administrator, (iv-1-2-2) acquire the ninth hash value as a result of said (iv-1-2-1), (iv-1-2-3) generate a tenth hash value by hashing at least one of the ownership token contract ID and the transaction server's digital wallet address, and (iv-1-2-4) check whether the ninth hash value matches with the tenth hash value, to thereby verify the fourth server signature value and the first administrator termination signature value to the k-th administrator termination signature value, and (iv-2) in response to verifying the fourth server signature value and the first administrator termination signature value to the k-th administrator termination signature value, execute the ownership token contract, to thereby terminate the specific ownership tokens transferred from the specific buyer among first buyer to the n-th buyer.

24. An online transaction server for distributing collectable ownership based on blockchain networks, comprising:
at least one memory that stores instructions; and
at least one processor configured to execute the instructions to perform processes of: (1) in response to acquiring a distribution request for a collectable from an owner who owns the collectable, (i) generating an ownership token contract for distributing an ownership of the collectable, (ii) generating a contract registering transaction which includes the ownership token contract and a first server signature value, which is a signature value of the online transaction server, and (iii) broadcasting the contract registering transaction to a blockchain network, to thereby instruct one or more blockchain nodes of the blockchain network to (iii-1) verify the first server signature value, (iii-2) in response to verifying the first server signature value, register the ownership token contract, included in the contract registering transaction, in the blockchain network, and (iii-3) transfer an ownership token contract ID corresponding to the ownership token contract registered in the blockchain network to the online transaction server; (b) the online transaction server, in response to acquiring each piece of ownership distribution participation information for participating in an ownership distribution of the collectable from each of a first buyer to an n-th buyer, wherein n is an integer greater than or equal to 1, according to an ownership distribution participation request for the collectable registered to distribute the ownership of the collectable, (i) generating each of a first multi-signature wallet contract to an n-th multi-signature wallet contract in order to distribute ownership tokens to each of the first buyer to the n-th buyer, (ii) generating at least one multi-signature wallet contract registering transaction which includes each of the first multi-signature wallet contract to the n-th multi-signature wallet contract and a second server signature value, which is a signature value of the online transaction server, and (iii) broadcasting the at least one multi-signature wallet contract registering transaction to the blockchain network, to thereby instruct the blockchain nodes of the blockchain network to (iii-1) verify the second server signature value, (iii-2) in response to verifying the second server signature value, register the first multi-signature wallet contract to the n-th multi-signature wallet contract included in the multi-signature wallet contract registering transaction in the blockchain network, and (iii-3) transfer a first multi-signature wallet contract ID to an n-th multi-signature wallet contract ID corresponding to the first multi-signature wallet contract to the n-th multi-signature wallet contract registered in the blockchain network to the online transaction server; and (3) the online transaction server (i) generating an ownership transferal transaction which includes the ownership token contract ID, ownership transferal information acquired by referring to the ownership distribution participation information, and a third server signature value which is a signature value acquired by signing (i-1) at least one of the ownership token contract ID and the ownership transferal information with a transaction server private key of the online transaction server, or (i-2) at least one first hash value of at least one of the ownership token contract ID and the ownership transferal information, and (ii) broadcasting the ownership transferal transaction to the blockchain network, to thereby instruct the blockchain nodes of the blockchain network to (ii-1) verify the third server signature value, and (ii-2) in response to verifying the third server signature value, execute the ownership token contract corresponding to the ownership token contract ID and thus transfer each of the ownership tokens corresponding to the collectable to each of the first multi-signature wallet contract to the n-th multi-signature wallet contract corresponding to each of the first buyer to the n-th buyer who have participated in the ownership distribution according to the ownership transferal information.

25. The online transaction server of claim 24, wherein, at the process of (3), the processor, in response to acquiring the ownership distribution participation information which includes first buyer distribution participation information to n-th buyer distribution participation information from the first buyer to the n-th buyer upon a completion of distributing the ownership of the collectable, (i) (i-1) broadcasts, to the blockchain network, the ownership transferal transaction which includes the ownership token contract ID, the ownership transferal information, and the third server signature value, wherein the ownership transferal information includes a first multi-signature wallet contract's address to an n-th multi-signature wallet contract's address and a first cardinal number of the ownership tokens to be transferred to an n-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, and the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract, to thereby transfer the first cardinal number of the ownership tokens to be transferred to the n-th cardinal number of the ownership tokens to be transferred respectively to the first multi-signature wallet contract's address to the n-th multi-signature wallet contract's address.

26. The online transaction server of claim 24, wherein, at the process of (3), the processor, in response to acquiring the ownership distribution participation information which includes k-th buyer distribution participation information upon a partial completion of distributing the ownership of the collectable by a k-th buyer among the first buyer to the n-th buyer, (i) (i-1) broadcasts, to the blockchain network, the ownership transferal transaction which includes the ownership token contract ID, the ownership transferal information, and the third server signature value, wherein the ownership transferal information includes a k-th multi-signature wallet contract's address and a k-th cardinal number of the ownership tokens to be transferred, and wherein the third server signature value is acquired by signing at least one of the ownership token contract ID and the ownership transferal information with the transaction server private key of the online transaction server, or (i-2) broadcasts, to the blockchain network, the ownership transferal transaction which includes the ownership token contract ID, the ownership transferal information, the third server signature value which is acquired by signing the first hash value with the transaction server private key, wherein the first hash value is acquired by hashing at least one of the ownership token contract ID and the ownership transferal information, and (ii) instructs the blockchain nodes to (ii-1) (ii-1-1) (ii-1-1-1) decrypt the third server signature value by using a transaction server public key of the online transaction server, (ii-1-1-2) acquire at least one of the ownership token contract ID and the ownership transferal information as a result of said (ii-1-1-1), and (ii-1-1-3) check whether the acquired at least one of the ownership token contract ID and the ownership transferal information matches with at least one of the ownership token contract ID and the ownership transferal information included in the ownership transferal transaction, to thereby verify the third server signature value, or (ii-1-2) (ii-1-2-1) decrypt the third server signature value by using the transaction server public key, (ii-1-2-2) acquire the first hash value as a result of said (ii-1-2-1), (ii-1-2-3) generate a second hash value by hashing at least one of the ownership token contract ID and the ownership transferal information, and (ii-1-2-4) check whether the first hash value matches with the second hash value, to thereby verify the third server signature value, and (ii-2) in response to verifying the third server signature value, execute the ownership token contract to transfer the k-th cardinal number of the ownership tokens to be transferred to the k-th multi-signature wallet contract's address, to thereby transfer the first cardinal number of the ownership tokens to be transferred to the n-th cardinal number of the ownership tokens to be transferred respectively to the first multi-signature wallet contract's address to the n-th multi-signature wallet contract's address.

27. The online transaction server of claim 24, wherein the ownership token contract includes information on an ownership token structure and an ownership token function corresponding to the collectable,
wherein the ownership token structure includes information on the collectable, information on an ownership token ID, and a cardinal number of issued ownership tokens,
wherein the information on the collectable includes at least part of information on a collectable ownership distribution ID, an item type of the collectable, a name of the collectable, a maker of the collectable, a brand of the collectable, a date of creation of the collectable, a size of the collectable, a color of the collectable, a material of the collectable, and an inspection result of the collectable, and
wherein the ownership token function includes at least part of an ownership token transferal function, an ownership token termination function, an ownership token balance checking function, an ownership token transfer history tracking function, an ownership token restriction function, an ownership token lookup function, and an ownership token holder lookup function.

28. The online transaction server of claim 24, wherein the processor further performs processes of: (4-1) (i) sending the ownership tokens to the first multi-signature wallet contract to the n-th multi-signature wallet contract through the blockchain network, to thereby allow a specific buyer among the first buyer to the n-th buyer who received an ownership token transferal request from a new buyer to (i-1) send an ownership token handover request corresponding to the ownership token transferal request to the online transaction server, (ii) in response to acquiring the ownership token handover request, generating a new multi-signature wallet contract in order to hand over the ownership tokens to the new buyer by referring to the ownership token handover request, (iii) generating a new multi-signature wallet contract registering transaction which includes the new multi-signature wallet contract and a fourth server signature value, which is a signature value of the online transaction server, and (iv) broadcasting the new multi-signature wallet contract registering transaction to the blockchain network, to thereby instruct the blockchain nodes to (iv-1) verify the fourth server signature value, (iv-2) in response to verifying the fourth server signature value, register the new multi-signature wallet contract included in the new multi-signature wallet contract registering transaction to the blockchain network, and (iv-3) transfer a new multi-signature wallet contract ID corresponding to the new multi-signature wallet contract registered in the blockchain network to the online transaction server; and (4-2) the online transaction server (i) generating an ownership token transferal task submission transaction which includes the ownership token contract ID, a new multi-signature wallet contract's address, a new cardinal number of ownership tokens to be transferred, and a fifth server signature value which is acquired by signing (i-1) at least one of the ownership token contract ID, the new multi-signature wallet contract's address, and the new cardinal number of ownership tokens to be transferred with the transaction server private key, or (i-2) at least one third hash value of at least one of the ownership token contract ID, the new multi-signature wallet contract's address, and the new cardinal number of ownership tokens to be transferred with the transaction server private key, to thereby broadcast the ownership token transferal task submission transaction to the blockchain network, (ii) instructing the blockchain nodes to (ii-1) (ii-1-1) decrypt the fifth server signature value by using a transaction server public key of the online transaction server (ii-1-2) acquire at least one of the ownership token contract ID, the new multi-signature wallet contract's address, and the new cardinal number of ownership tokens to be transferred as a result of said (ii-1-1), and (ii-1-3) check whether the acquired at least one of the ownership token contract ID, the new multi-signature wallet contract's address, and the new cardinal number of ownership tokens to be transferred matches with at least one of the ownership token contract ID, the new multi-signature wallet contract's address, and the new cardinal number of ownership tokens to be transferred included in the ownership token transferal task submission transaction, to thereby verify the fifth server signature value, or (ii-2) (ii-2-1) decrypt the fifth server signature value by using the transaction server public key, (ii-2-2) acquire the third hash value as a result of said (ii-2-1), (ii-2-3) generate a fourth hash value by hashing at least one of the ownership token contract ID, the new multi-signature wallet contract's address, and the new cardinal number of ownership tokens to be transferred, and (ii-2-4) check whether the third hash value matches with the fourth hash value, to thereby verify the fifth server signature value, (iii) requesting each of a first multi-signer to an m-th multi-signer to multi-sign an ownership token transferal task submission transaction ID corresponding to the ownership token transferal task submission transaction, wherein m is an integer greater than or equal to 1, (iv) generating each of ownership token transferal task approval transactions which includes each of a first multi-signer transferal signature value to a j-th multi-signer transferal signature value and the ownership token transferal task submission transaction ID, wherein each of the first multi-signer transferal signature value to the j-th multi-signer transferal signature value is acquired by signing (iv-1) the ownership token transferal task submission transaction ID with each of multi-signer private keys of the first multi-signer to a j-th multi-signer, or (iv-2) a fifth hash value of the ownership token transferal task submission transaction ID with each of the multi-signer private keys of the first multi-signer to the j-th multi-signer, and wherein j is an integer greater than or equal to 1 and less than m, (v) sending each of the ownership token transferal task approval transactions from each of the first multi-signer to the j-th multi-signer to the blockchain network, and (vi) instructing the blockchain nodes to (vi-1) (vi-1-1) (vi-1-1-1) decrypt the first multi-signer transferal signature value to the j-th multi-signer transferal signature value by using each of multi-signature public keys of the first multi-signer to the j-th multi-signer, (vi-1-1-2) acquire the ownership token transferal task submission transaction ID as a result of said (vi-1-1-1) and, (vi-1-1-3) check whether the acquired ownership token transferal task submission transaction ID matches with the ownership token transferal task submission transaction ID included in each of the ownership token transferal task approval transactions, to thereby verify the first multi-signer transferal signature value to the j-th multi-signer transferal signature value, or (vi-1-2) (vi-1-2-1) decrypt the first multi-signer transferal signature value to the j-th multi-signer transferal signature value by using each of the multi-signature public keys, (vi-1-2-2) acquire the fifth hash value as a result of said (vi-1-2-1), (vi-1-2-3) generate a sixth hash value by hashing the ownership token transferal task submission transaction ID, and (vi-1-2-4) check whether the fifth hash value matches with the sixth hash value, to thereby verify the first multi-signer transferal signature value to the j-th multi-signer transferal signature value included in each of the ownership token transferal task approval transactions, and (vi-2) in response to verifying the fifth server signature value to be valid and in response to checking that a cardinal number of multi-signer transferal signature values verified to be valid among the first multi-signer transferal signature value to the j-th multi-signer transferal signature value is greater than a predetermined number, execute a specific multi-signature wallet contract corresponding to the specific buyer, to thereby transfer the new cardinal number of ownership tokens to be transferred to the new multi-signature wallet contract's address according to the ownership token contract.

29. The online transaction server of claim 24, wherein the processor further performs a process of: (5) in response to acquiring sale completion information, (i) generating an ownership token termination task submission transaction which includes the ownership token contract ID and a sixth server signature value which is acquired by (i-1) signing the ownership token contract ID with a transaction server private key of the online transaction server or (i-2) signing a seventh hash value of the ownership token contract ID with the transaction server private key, to thereby broadcast the ownership token termination task submission transaction to the blockchain network, (ii) instructing the blockchain nodes to (ii-1) (ii-1-1) decrypt the sixth server signature value by using a transaction server public key of the online transaction server, (ii-1-2) acquire the ownership token contract ID as a result of said (ii-1-1), and (ii-1-3) check whether the acquired ownership token contract ID matches with the ownership token contract ID included in the ownership token termination task submission transaction, to thereby verify the sixth server signature value, or (ii-2) (ii-2-1) decrypt the sixth server signature value by using the transaction public key, (ii-2-2) acquire the seventh hash value as a result of (ii-2-1), (ii-2-3) generate an eighth hash value by hashing the ownership token contract ID, and (ii-2-4) check whether the seventh hash value matches with the eighth hash value, to thereby verify the sixth server signature value, (iii) requesting each of a first multi-signer to an m-th multi-signer to multi-sign an ownership token termination task submission transaction ID corresponding to the ownership token termination task submission transaction, wherein m is an integer greater than or equal to 1, (iv) generating each of ownership token termination task approval transactions which includes each of a first multi-signer termination signature value to a j-th multi-signer termination signature value and the ownership token termination task submission transaction ID, wherein each of the first multi-signer termination signature value to the j-th multi-signer termination signature value is acquired by signing (iv-1) the ownership token termination task submission transaction ID with each of multi-signer private keys of the first multi-signer to the j-th multi-signer, or (iv-2) a ninth hash value of the ownership token termination task submission transaction ID with each of the multi-signer private keys of the first multi-signer to the j-th multi-signer, and wherein j is an integer greater than or equal to 1 and less than m, (v) broadcasting each of the ownership token termination task approval transactions from each of the first multi-signer to the j-th multi-signer to the blockchain network, and (vi) instructing the blockchain nodes to (vi-1) (vi-1-1) (vi-1-1-1) decrypt the first multi-signer termination signature value to the j-th multi-signer termination signature value by using each of multi-signature public keys of the first multi-signer to the j-th multi-signer, (vi-1-1-2) acquire the ownership token termination task submission transaction ID as a result of said (vi-1-1-1) and, (vi-1-1-3) check whether the acquired ownership token termination task submission transaction ID matches with the ownership token termination task submission transaction ID included in each of the ownership token termination task approval transactions, to thereby verify the first multi-signer termination signature value to the j-th multi-signer termination signature value, or (vi-1-2) (vi-1-2-1) decrypt the first multi-signer termination signature value to the j-th multi-signer termination signature value by using each of the multi-signature public keys, (vi-1-2-2) acquire the ninth hash value as a result of said (vi-1-2-1), (vi-1-2-3) generate a tenth hash value by hashing the ownership token termination task submission transaction ID, and (vi-1-2-4) check whether the ninth hash value matches with the tenth hash value, to thereby verify each of the first multi-signer termination signature value to the j-th multi-signer termination signature value included in each of the ownership token termination task approval transactions, and (vi-2) in response to verifying the sixth server signature value to be valid and in response to checking that a cardinal number of multi-signer termination signature values verified to be valid among the first multi-signer termination signature value to the j-th multi-signer termination signature value is greater than or equal to a predetermined number, execute the first multi-signature wallet contract to the n-th multi-signature wallet contract, to thereby terminate the ownership tokens according to the ownership token contract.

30. The online transaction server of claim 24, wherein each of the first multi-signature wallet contract to the n-th multi-signature wallet contract includes information on a multi-signature structure and a multi-signature function,
wherein the multi-signature structure includes information on at least part of a cardinal number of people taking part in multi-signature, a minimum number of multi-signatures required to validate a multi-signature, and addresses of multi-signers, and
wherein the multi-signature function includes at least part of an ownership token related task submission function, an ownership token related task approval function, an ownership token related task executing function, a multi-signer adding function, a multi-signer deleting function, and a number changing function for changing the minimum number of multi-signatures.
